(19) United States
(12) Patent Application Publication
(10) Pub. No.: US 2013/0318020 A1
(43) Pub. Date: Nov. 28, 2013

(54) ANALOG PROGRAMMABLE SPARSE APPROXIMATION SYSTEM

(71) Applicant: Georgia Tech Research Corporation, (US)

(72) Inventors: Samuel SHAPERO, Atlanta, GA (US); Jennifer O. Hasler, Atlanta, GA (US); Christopher John Rozell, Atlanta, GA (US)

(73) Assignee: Georgia Tech Research Corporation, Atlanta, GA (US)

(21) Appl. No.: 13/669,316

(22) Filed: Nov. 5, 2012

Related U.S. Application Data
(60) Provisional application No. 61/555,171, filed on Nov. 3, 2011.

(51) Int. Cl. G06N 3/04

(52) U.S. Cl. CPC G06N 3/0445
USPC 706/30

(57) ABSTRACT

A system and device for solving sparse algorithms using hardware solutions is described. The hardware solution can comprise one or more analog devices for providing fast, energy efficient solutions to small, medium, and large sparse approximation problems. The system can comprise sub-threshold current mode circuits on a Field Programmable Analog Array (FPAA) or on a custom analog chip. The system can comprise a plurality of floating gates for solving linear portions of a sparse signal. The system can also comprise one or more analog devices for solving non-linear portions of sparse signal.

### CROSS REFERENCE TO RELATED APPLICATIONS

This application claims benefit under 35 USC §119(e) of U.S. Provisional Patent Application Ser. No. 61/555,171, of the same title, and filed Nov. 3, 2011, which is herein incorporated by reference as if fully set forth below in its entirety.

### GOVERNMENT LICENSE RIGHTS

This invention was made with Government support under Agreement/Contract Number CCF-0905346, awarded by National Science Foundation. The Government has certain rights in the invention.

### BACKGROUND

1. Technical Field

Embodiments of the present invention relate generally to sparse approximation and specifically to sparse approximation using accurate, energy efficient, analog sparse approximation with reduced energy consumption and reduced computational expense.

2. Background of Related Art

As shown in FIG. 1A, sparse approximation seeks to represent a vector (e.g., an electronic signal) by using relatively few elements from a prescribed dictionary. Modern signal processing has tended toward nonlinear optimizations rather than linear filtering, however, because this approach tends to be compatible with statistically rich (i.e., non-Gaussian) signal models. In particular, sparse approximation is a significant component in current state-of-the-art approaches for many application areas, including inverse problems. Which can include, for example and not limitation, denoising, restoration, data recovery from undersampled measurements, computer vision, and machine learning.

One specific example of sparse approximation is compressed sensing (CS) (e.g., attempting to create a high-resolution image from relatively few measurements). CS tends to provide results for inverse problems when the signals are highly undersampled (M<<N where M measurements are taken of a length N signal) and the signal is assumed to be sparse (i.e., having very few non-zeros in the signal). CS results indicate that for certain sensing matrices Φ (generally taken to be random), S-sparse signals can be recovered (up to the noise level) by solving an l₁ regularized least-squares optimization problem as long as M˜O(S log(N/S)). In other words, in a situation where each measurement is costly, a signal can be undersampled during acquisition in exchange for using more computational resources to later recover the signal.

This technique can be used, for example, for coded aperture sensing systems that spend fewer resources to collect data at a specified resolution, relying instead on computational post-processing to reconstruct the signal. Unfortunately, the optimization problems used for signal recovery are computationally expensive, preventing practical deployment of digital solutions for portable, low-power applications (e.g., handheld medical imagers or scanners).

Despite the long history of optimization in the field of signal processing, the recent advent of applications that utilize optimization directly to perform CS, for example, identifies a specific need for solvers that can operate in real time and/or under real-world power constraints. This type of signal processing can be useful for, for example and not limitation, for medical imaging and channel estimation for wireless communications.

Given the importance of solving sparse approximation problems in state-of-the-art algorithms, therefore, recent research has focused on dramatically reducing their solution times. These optimization programs are particularly challenging due to the presence of the matrix norm, l₁-norm, in the objective because this makes the program non-smooth. Thus, despite recent progress in developing convex optimization solvers, this non-smoothness provides significant challenges for obtaining real-time results for moderate to large-sized problems.

What is needed, therefore, is a system for recovering sparse signals, for example, with reduced computational time and expense. What is needed is a system for solving widely used sparse approximation problems using commonly available and efficient analog circuitry. It is to such a system that embodiments of the present invention are primarily directed.

### SUMMARY

Embodiments of the present invention relate generally to optimization problems utilizing Hopfield networks and specifically to an analog hardware implementation of a Hopfield network. In some embodiments, the system can be used for sparse approximation using accurate, energy efficient, analog sparse approximation. This system can provide sparse approximation with reduced energy consumption and reduced computational expense. In some embodiments, the system can comprise sub-threshold current mode circuits on a Field Programmable Analog Array (FPAA) or on a custom analog chip.

Embodiments of the present invention can comprise a method comprising applying each of a plurality of input signals to each of a plurality of feedforward excitation signals to generate a plurality of first output signals, applying each of a plurality of second output signals to each of a plurality of lateral inhibition signals to generate a plurality of recurrent feedback signals, subtracting each the plurality of recurrent feedback signals from each of the plurality of first output signals to generate a plurality of intermediate signals, and applying each of the plurality of intermediate signals to a non-linear computation to generate a plurality of second output signals.

In some embodiments, the method can further comprise converting a first sparse vector of a plurality of sparse vectors to a plurality of input signals. In some embodiments, the plurality of feedforward excitation signals can be applied by a first plurality of transistors that comprise a first analog vector matrix multiplier (VMM). In other embodiments, the plurality of lateral inhibition signals can be applied by a second plurality of transistors that comprise a second analog vector matrix multiplier (VMM). In still other embodiments, the subtraction step can be performed by a plurality of current minors.

In some embodiments, each step can be performed in parallel in continuous time for each input signal of the plurality of input signals. In other embodiments, the plurality of first output signals and the plurality of recurrent feedback signals can be analog, while the plurality of second output signals can be digital. In some embodiments, one or more of the plurality of first output signals and the recurrent feedback signals can change in response to a change in one or more of the plurality of second output signals. In some embodiments, a change in one or more of the plurality of first output signals or the recurrent feedback signals can act as a low-pass filter. I

Embodiments of the present invention also comprise a device for implementing a Hopfield network. In some embodiments, the device can comprise a plurality of first parallel linear computational devices for applying each of a plurality of input signals to each of a plurality of feedforward excitation signals to generate a plurality of first output signals, a plurality of second parallel linear computational devices for applying each of a plurality of second output signals to each of a plurality of lateral inhibition signals to generate a plurality of recurrent feedback signals, and a plurality of non-linear parallel computational devices for subtracting each of the plurality of recurrent feedback signals from each of the plurality of first input signals to generate a plurality of intermediate signals and applying each of the plurality of intermediate signals to generate a plurality of second output signals.

In some embodiments, the device can further comprise a plurality of digital-to-analog converters for converting a plurality of digital signals into the plurality of input signals. In other embodiments, the plurality of first parallel linear computational devices can comprise a first plurality of transistors forming a first analog vector matrix multiplier (VMM). In some embodiments, each scalar multiplication in the first analog VMM can require only one of the first plurality of transistors. In some embodiments, one or more of the first plurality of transistors can be programmable.

In some embodiments, the plurality of second parallel linear computational devices can comprise a second plurality of transistors forming a second analog VMM. In other embodiments, each scalar multiplication in the second analog VMM can require only one of the plurality of transistors. In still other embodiments, one or more of the first plurality of transistors can be programmable. In yet other embodiments, the plurality non-linear parallel computational devices comprise a plurality of n-channel field effect transistors (nFET).

In some embodiments, the device can further comprise one or more low-pass filters. In some embodiments, each of the plurality of non-linear parallel computational devices can comprise an individually tunable negative offset and an integrate and fire neuron. In some embodiments, these integrate and fire neurons can comprise non-leaky integrate and fire neurons.

Embodiments of the present invention can also comprise a system for implementing a Hopfield network. In some embodiments, the system can comprise a field programmable analog array (FPAA). The FPAA can comprise a first plurality of transistors forming a first vector multiplication matrix (VMM) for applying the each of the plurality of input signals to each of a plurality of feedforward excitation signals to generate a plurality of first output signals, a second plurality of transistors forming a second vector multiplication matrix (VMM) for applying each of a plurality of second output signals to each of a plurality of lateral inhibition signals to generate a plurality of recurrent feedback signals, and a plurality of modified current mirrors for subtracting each of the plurality of recurrent feedback signals from each of the plurality of first input signals to generate a plurality of intermediate signals and applying each of the plurality of intermediate signals to a non-linear computation to generate a plurality of second output signals.

In some embodiments, the system can further comprise a plurality of digital-to-analog converters for converting a first sparse vector from a plurality of sparse vectors into a plurality of input signals. In other embodiments, each scalar multiplication in the first VMM or the second VMM can require only one transistor of the first or second plurality of transistors. In still other embodiments, each of the first and second plurality of transistors can comprises one or more floating gates and the charge on each of the one or more floating gates can determine the weight of the scalar multiplication produced by that transistor.

In some embodiments, each of the modified current mirrors can comprise a negative offset current. In other embodiments, the negative offset current can be individually tunable for each of the modified current minors. In still other embodiments, the negative offset current can be provided by a floating gate transistor and the charge of the floating gate transistor can determine the magnitude of the negative current offset. In still other embodiments, the nonlinear computations comprise integrate and fire neurons.

These and other objects, features and advantages of the present invention will become more apparent upon reading the following specification in conjunction with the accompanying drawing figures.

### BRIEF DESCRIPTION OF THE FIGURES

FIG. 1a compares a locally competitive algorithm (LCA) implemented on a field programmable analog array (FPAA) and a digital solver, in accordance with some embodiments of the present invention.

FIG. 1b depicts a linear generative model for sparse encodings, in accordance with some embodiments of the present invention.

FIG. 2a depicts a block diagram of a 2×3 LCA with ammeters, in accordance with some embodiments of the present invention.

FIGS. 2b-2d compares outputs of the LCA against theoretical ideals, in accordance with some embodiments of the present invention.

FIG. 3 depicts a vector matrix multiplier (VMM) using floating-gate transistors, in accordance with some embodiments of the present invention.

FIG. 4a is a block diagram of an analog soft-thresholder, in accordance with some embodiments of the present invention.

FIG. 4b depicts the response of the soft thresholder of FIG. 4a, in accordance with some embodiments of the present invention.

FIG. 5 is a dye photo of the RASP 2.9 v FPAA chip, in accordance with some embodiments of the present invention.

FIG. 6a is a graph depicting the root mean square error (RMSe) of the LCA compared to a digital solution, in accordance with some embodiments of the present invention.

FIG. 6b is a graph comparing the LCA solution and the digital solution, in accordance with some embodiments of the present invention.

FIG. 7 is a block diagram of the current minor and VMM used to determine operational transconductance amplifier (OTA) biasing, in accordance with some embodiments of the present invention.

FIG. 8a is a graph depicting the convergence of the 4×6 LCA to the final value, in accordance with some embodiments of the present invention.

FIG. 8b is a block diagram of the current to voltage convertor for the LCA, in accordance with some embodiments of the present invention.

FIG. 9 is a graph of the dynamics of the thresholder circuit, in accordance with some embodiments of the present invention.

FIGS. 10a and 10b depict block diagrams of the LCA with a spiking LCA, respectively, in accordance with some embodiments of the present invention.

FIG. 11a is a graph depicting the RMSe of the LCA solution when compared to a digital solution (L1-LS), in accordance with some embodiments of the present invention.

FIG. 11b is a graph comparing the convergence of the LCA with the digital solution, in accordance with some embodiments of the present invention.

FIGS. 12a and 12b are block diagrams of the ideal integrate and fire neuron and the actual integrate and fire neuron, respectively, in accordance with some embodiments of the present invention.

FIG. 12c is a graph depicting the response of the neuron in the spiking LCA, in accordance with some embodiments of the present invention.

FIG. 12d is a graph depicting the non-ideal response of the neuron in the spiking LCA, in accordance with some embodiments of the present invention.

FIG. 13a is a block diagram of the ideal wave shaping circuit and synapses, in accordance with some embodiments of the present invention.

FIG. 13b is a block diagram of the actual wave shaping circuit and synapses, in accordance with some embodiments of the present invention.

FIG. 13c is a graph depicting the waveform of the wave shaping circuit, in accordance with some embodiments of the present invention.

FIG. 14a compares the spiking LCA and a digital solver, in accordance with some embodiments of the present invention.

FIG. 14b depicts a linear generative model for sparse encodings, in accordance with some embodiments of the present invention.

FIGS. 15a-16c compare results from the spiking LCA and a digital solution (L1-LS), in accordance with some embodiments of the present invention.

FIG. 17a is a graph depicting the response of the spiking LCA, in accordance with some embodiments of the present invention.

FIG. 17b is a block diagram for a portion of the spiking LCA, in accordance with some embodiments of the present invention.

These and other objects, features and advantages of the present invention will become more apparent upon reading the following specification in conjunction with the accompanying drawing figures.

### DETAILED DESCRIPTION

Embodiments of the present invention relate generally to sparse approximation and specifically to a system for sparse approximation using accurate, energy efficient, analog sparse approximation. This system can provide sparse approximation with reduced energy consumption and reduced computational expense. In some embodiments, the system can comprise sub-threshold current mode circuits on a Field Programmable Analog Array (FPAA) or on a custom analog chip.

To simplify and clarify explanation, the system is described below as a system for solving sparse problems using an FPAA. One skilled in the art will recognize, however, that the invention is not so limited and, for example, other analog or digital circuitry can be used. In addition, while explained below in the context of solving sparse approximations, one of skill in the art will recognize that the system and method is more generally a hardware implementation of a Hopfield Network. As such, the system and method could also be used to solve other optimization problems such as, for example and not limitation, quadratic programs/linear programs (QPs/LPs). For ease of explanation, specific components (e.g., CMOS chips) are described below; however, one skilled in the art will recognize that existing and future components and algorithms can be used.

The materials described hereinafter as making up the various elements of the present invention are intended to be illustrative and not restrictive. Many suitable materials that would perform the same or a similar function as the materials described herein are intended to be embraced within the scope of the invention. Such other materials not described herein can include, but are not limited to, materials that are developed after the time of the development of the invention, for example. Any dimensions listed in the various drawings are for illustrative purposes only and are not intended to be limiting. Other dimensions and proportions are contemplated and intended to be included within the scope of the invention.

As discussed above, a problem with current Hopfield Networks, in general, and sparse signal recovery algorithms, in particular, is that they are computationally expensive and time consuming, preventing practical deployment of digital solutions for portable, low-power applications. Recent work in computational neuroscience, however, has demonstrated that a continuous-time dynamical system where (1) the steady-state response is the solution to a regularized least-squares optimization and (2) the architecture of the system is designed to efficiently deal with sparsity-inducing non-smoothness conditions can be effective and efficient. This Hopfield Neural-Network-like architecture can enable the use of analog circuitry, which can provide several benefits.

Even the most efficient iterative digital algorithms currently available require O(N²) floating point operations per iteration. In contrast, the solution time in a parallel analog architecture is proportional to the RC time constant, which scales O(N)). In other words, the analog solution is exponentially more efficient. In addition, total energy consumption can also be reduced by using analog vector matrix multipliers (VMMs) that require only one transistor per multiplication (i.e., instead of using the large multipliers required for digital processing). Using a programmable analog device like, for example and not limitation, an FPAA enables the implementation and testing of circuits without the time and cost of chip fabrication and also enables compensation for errors caused by the inherent mismatch in transistor sizes.

Embodiments of the present invention, therefore, can comprise an analog approach to implementing a Hopfield network that can provide solutions with lower power, greater speed, and better scaling properties than is possible in conventional digital solutions. The system can enable significantly a number of practical applications that would otherwise not be possible, even with substantial improvements in digital algorithms, due to time and/or power constraints. In CS applications, as discussed above, an analog system can be especially powerful, enabling signals to be acquired (e.g., with coded apertures) and recovered very quickly. This can eliminate the post-processing, for example, that has become the “accepted” bottleneck with CS systems.

Optimization Problem Formulation

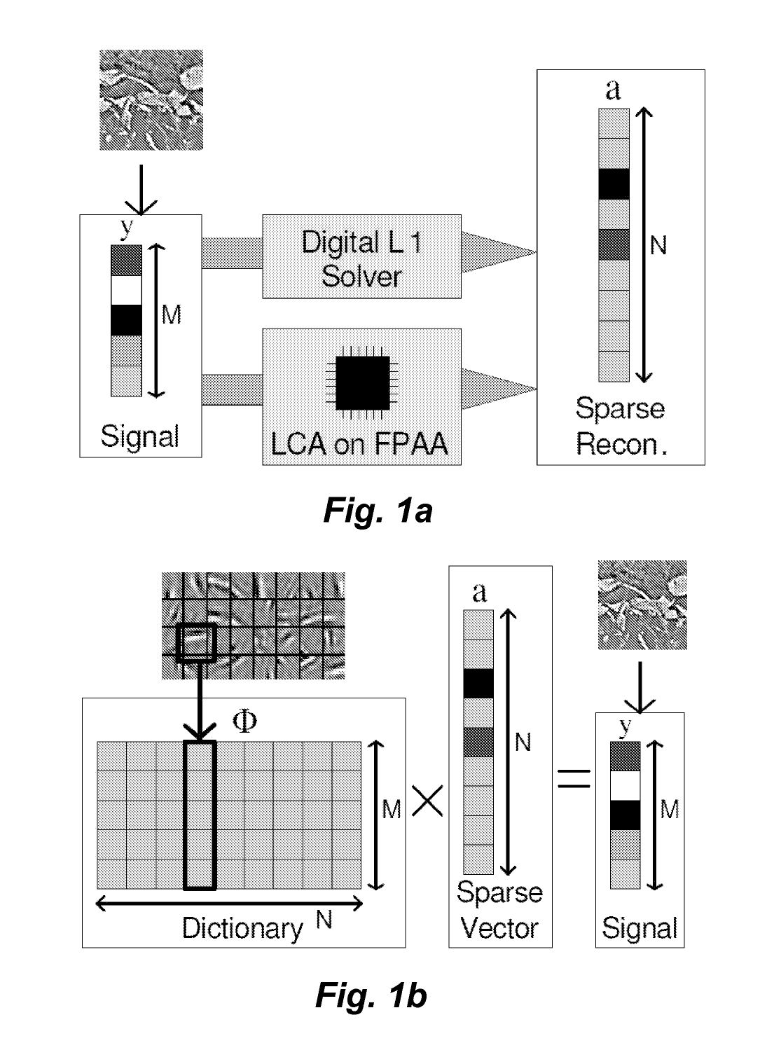

As discussed above, sparse approximation methods achieve efficient signal representations by using only a small subset of dictionary elements and taking advantage of the known statistical structure of the signal. As shown in FIG. 1b, these methods generally assume a linear generative model for signal representation:

y=Φa+v (1)

Where a vector input yε [symbol] ^{M} is represented with an over complete dictionary Φ=[φ₁, . . . , φ_{N}] using coefficients aε [symbol] ^{N}, with additive Gaussian white noise v. Given these definitions, the desired Maximum A-Posteriori (MAP) estimate of the linear generative model, assuming a sparse prior distribution on coefficients a:

$${argmax}_{a} ( P ( a / y ) = {argmax}_{a} P ( y / a ) P ( a ) , \\ P ( a ) ∝ {\prod }_{j}^{ } {e}^{- C ( {a}_{j} )} \qquad ( 2 )$$

where C(•) is a sparsity-inducing cost function (e.g., lₒ-Norm). Unfortunately, direct optimization of the problem—i.e., where C(•) counts non-zeros—is intractable. In some embodiments, Therefore, Basis Pursuit De-Noising (BPDN) can be used. In this technique, a common surrogate for l₀-Norm optimization uses C(•) set to the l₁-Norm. In this configuration, Eq. 3, below, is equivalent to the convex optimization:

$$arg {min}_{a} ( \frac{1}{2} {‖ y - Φ a ‖}_{2}^{2} + λ {‖ a ‖}_{1} ) . \qquad ( 3 )$$

where the first term in the objective function represents the mean squared error of the approximation, the second term represents the sparsity of the solution via the l₁-Norm, ∥a∥₁=Σᵢ|aᵢ|, and λ is a tradeoff parameter (e.g., balancing data fidelity against solution sparsity).

### LCA Architecture

A locally competitive algorithm (LCA) can be described as a system of nonlinear ordinary differential equations (ODEs). Fortunately, as discussed below, these equations translate readily into a Hopfield-Network-like system architecture.

System of Differential Equations

In some embodiments, the LCA can be a continuous time algorithm which acts on a set of internal state variables, uₘ(t) for m=1, . . . , M. Fortunately, these internal states are guaranteed to exponentially converge to the equilibrium state, which is the solution to the objective function in Eq. 3. Restricting a(t)>0, the dynamics of the nodes can be described by the following set of ODEs:

τ\dot{u}(t)+u(t)=b−(Φ^{t}Φ−I)a(t),

a(t)=T_{λ}(u(t))=max(0,u(t) (4)

where τ is the time constant of the system, and bε [symbol] ^{M}= [symbol] is the vector of driving inputs. The feedback between the nodes can be computed by H=Φ^{t}Φ−I. The sparsity constraint and the nonlinearity can be introduced by the threshold operator T_{λ}(•), which decreases the absolute value of u(t) by λ. Once the state variables u(t) have reached equilibrium, the output vector a(t) is the solution to the objective function.

System Architecture for Hardware

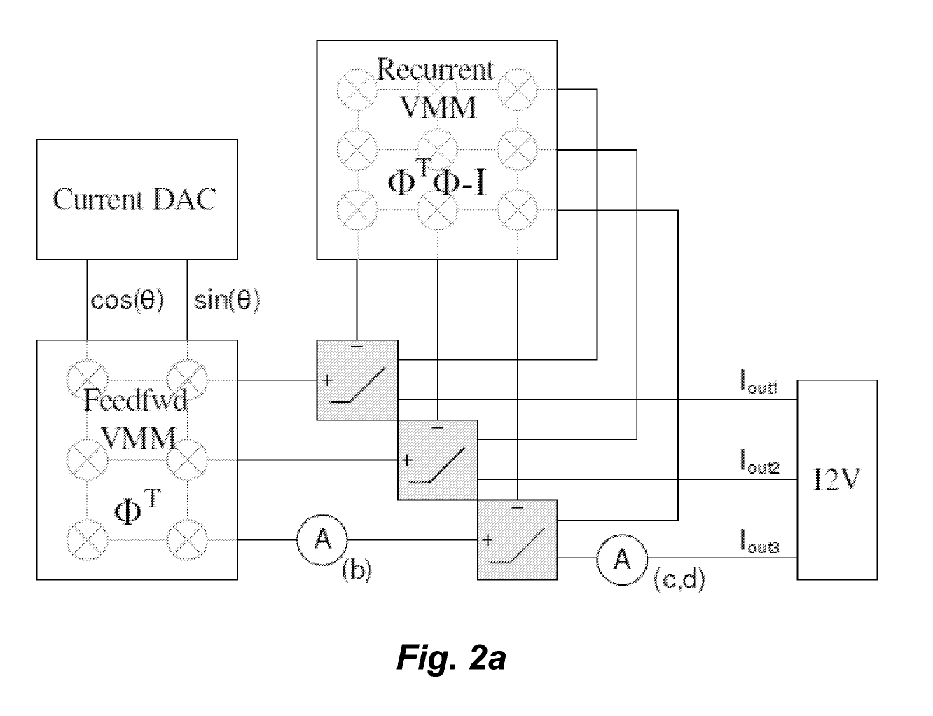

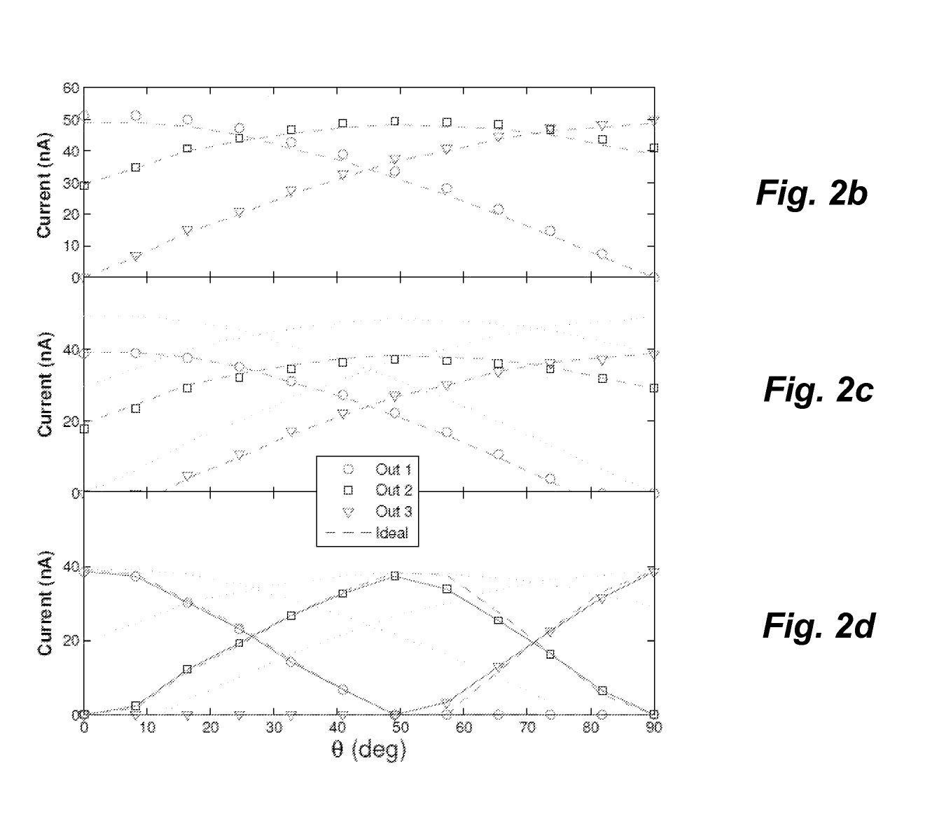

As in most neural networks, the internal state variables in Eq. 4 evolve in a parallel fashion. The architecture of the LCA can be implemented as an analog hardware system, an example of which is presented in FIG. 2a. The system can be composed of current mode VMMs and current mirrors (including a double current mirror that implements the soft-threshold operation).

The first VMM represents a feedforward multiplier. It accepts the input vector y from the Current Digital-to-Analog Converters (DACS) (after they are mirrored) and performs the operation b= [symbol] to compute the driving inputs. The second block, or recurrent VMM, performs the operation h(t)=Ha(t) and computes the recurrent feedback. It should be noted that the feedback is similar to a stable, convergent Hopfield Network. In other words, nodes do no inhibit themselves (i.e., H_{m,m}=0) and the inhibition between nodes is symmetric (i.e., H_{m,n}=H_{n,m}).

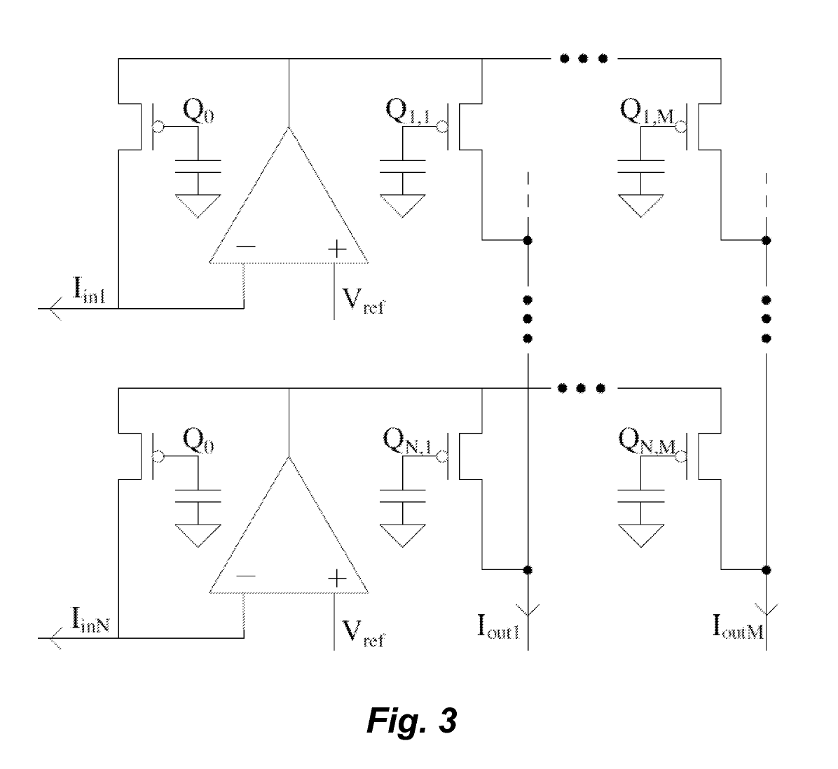

As shown in FIG. 3, both of the VMMs can be implemented as current mode devices. This can be useful because these devices have relatively small areas, low power requirements, and are easily scalable, while operating in the sub-threshold region. The VMMs can perform the linear operation I_{OUT}=WI_{IN}. The charge on each FGE determines the weight of each scalar multiplication.

In a preferred embodiment, for scalar multiplication accuracy, the input and output devices should have matching drain voltages. To this end, the input drain voltage can be regulated with an operational transconductance amplifier (OTA) that provides a power source to both the input and output currents. In this configuration, the OTA can scale the input power with the number and strength of the outputs.

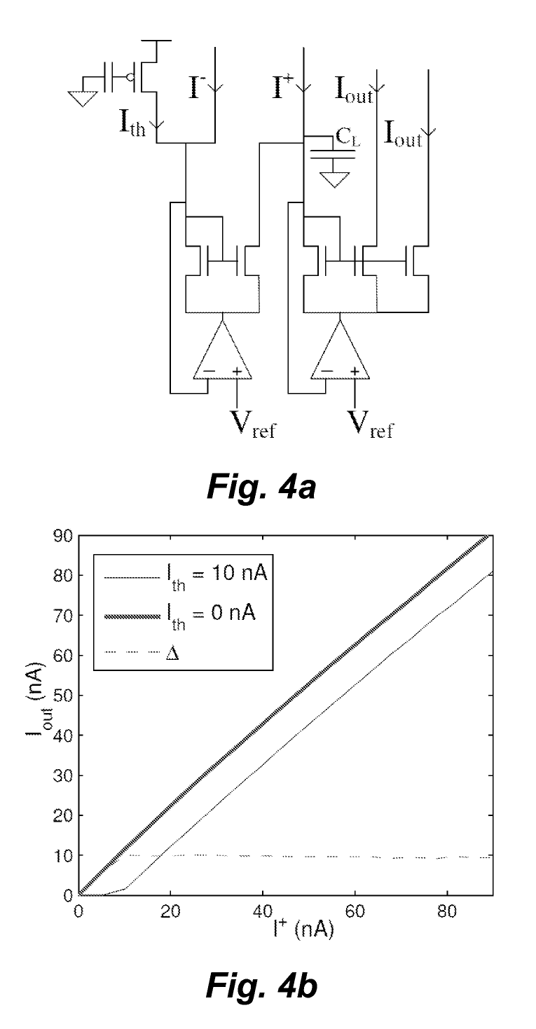

As shown in FIG. 4a, the system can also comprise a double n-channel field effect transistor (nFET) current mirror. The nFET can be used to find the difference of the linear terms b−(h+λ), and can apply a capacitive load to induce a low pass filter with time constant. The active current mirrors, in turn, can each accept a current into a corresponding nFET. In this configuration, the circuit causes another nFET to have the same gate, and source voltages, thus producing the same current. In addition, because the input nFET also acts a rectifying diode, the current mirror can only pass positive currents. As shown in FIG. 4b, introducing the negative offset λ makes this device an effective soft-thresholder.

In a preferred embodiment, for improved accuracy of the current minor, the nFETs can be well matched and have substantially identical drain voltages. To this end, mismatch can be minimized by simply enlarging the devices. Fortunately, this enlargement is not a major factor with regard to system density because there are O(N) mirrors, but O(N²) VMMs. In other words, the number of mirrors is exponentially smaller than the number of VMMs and, thus, does not have a significant effect on system size. As with the VMMs, OTAs can be used to regulate the input drain voltage. In addition, because the minor outputs are the same as the VMM inputs (which also have a regulated voltage), the drain voltages are matched. Similarly, the current minor OTAs also allow matching of the drain voltages in the VMM.

The transfer function of the double current mirror is then:

τ\dot{u}(t)+u(t)=b−h(t)

a(t)=T_{λ}(u(t)) (5)

From the VMMs, we get b=Φ^{T}y and h=(Φ^{T}Φ−I)a(t). Thus, combining these relationships yields the original Eq. 4.

### Example 1

### LCA Circuitry on Reconfigurable Analog Hardware

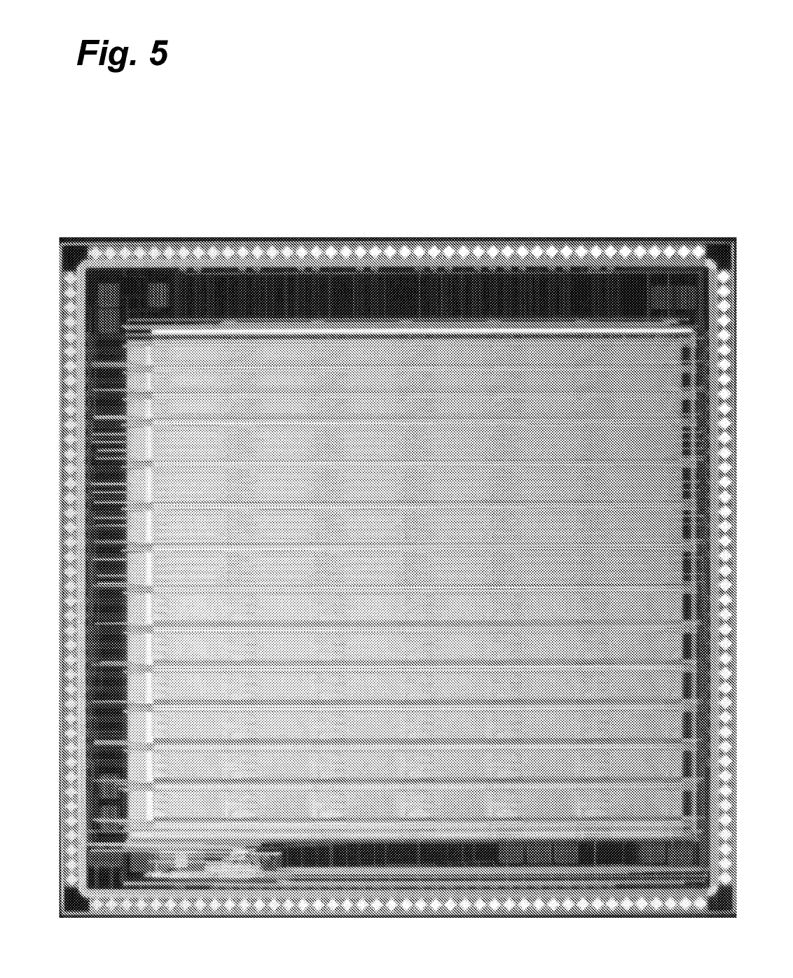

As shown in FIG. 5, in some embodiments, a reconfigurable analog signal processor (RASP) 2.9 v can be used. In this case, a 350 nm double-poly CMOS chip can be used. The chip can further comprise, for example and not limitation, several computational analog blocks (CABs), a large matrix of programmable floating gate elements (FGEs) for routing, and a plurality of (in this case, 26) chip spanning volatile switch lines. These switch lines enable rapid scanning of every internal node in the chip. The CABs can comprise a variety of analog elements including, but not limited to, the OTAs and nFETs used in the LCA. The chip can also comprise a plurality of CABs (in this case, 18) dedicated for current-mode digital to analog conversion (DACs). This configuration enables the system inputs to be quickly reprogrammed.

In some embodiments, the RASP 2.9 v can comprise several design innovations that make it particularly well suited for implementing and testing the LCA. The majority of the FGEs are directly programmed devices, for example, meaning that the programmed device is directly in the final circuit. Thus, while this adds a selection register to the signal path, it also eliminates mismatch issues seen in earlier FPAAs. The direct devices allow the programming of current sources (e.g., those needed for the threshold current and inputs) to 7 bits of accuracy. This represents less than 1% error.

An automated calibration routine can be used and can comprise the Enz Krummenacher-Vittoz (EKV) model to determine the relationship between the floating gate programming targets and the multiplier weight. On the RASP 2.9 v, this routine improves the programming of current-mode VMMs to 6 bits of accuracy.

Control and communication with the RASP 2.9 v can be provided by a USB connection to an AT91sam7s Microcontroller. Of course, the microcontroller can also communicate with onboard ADCs and DACs, which enables analog voltages on the FPAA to be set and read. In some embodiments, the interface with the Microcontroller can be provided by a suite of commands (e.g., Mathworks MATLAB©) or similar scripts written in MATLAB© can also enable the programming and testing to be automated. In other embodiments, a series of chain of tools for the RASP chips can enable the user to convert an entire library of functions into circuits, for example, and then to place and route these circuits on the RASP 2.9 v.

Multiple LCA systems were implemented on the RASP 2.9 v and are discussed below. The smaller of these was a single-ended 2×3 system (two inputs, three outputs), built for illustrative purposes. Because the input vector preferably coincides with the unit circle, the input in practice had only one degree of freedom, making the results easier to display. Its dictionary was:

$$Φ = [ \begin{matrix}1 & .6 & 0 \\ 0 & .8 & 1\end{matrix} ] .$$

A larger single-ended 4×6 system was also implemented to demonstrate the scalability of the system architecture:

$$Φ = [ \begin{matrix}1 & 0 & 0 & 0 & .47 & .59 \\ 0 & 1 & 0 & 0 & .59 & .47 \\ 0 & 0 & 1 & 0 & .65 & .1 \\ 0 & 0 & 0 & 1 & .1 & .65\end{matrix} ] .$$

The six dictionary elements are chosen to fully span the input domain and to observe the restricted isometry property (RIP), i.e., where the eigenvalues of the matrix are restricted to a certain range. While a matrix of random Gaussian variables is typically used to satisfy the RIP, the dimensions were small enough here that a set matrix could do so more easily.

In addition to the necessary VMMs and current mirrors, on-chip 8-bit current DACs can be programmed to allow control of the input currents. These inputs can be normalized to a ratio of 60 nA:l. The threshold current I_{λ} was programmed to 6 nA, which results in a tradeoff parameter of λ=0.1.

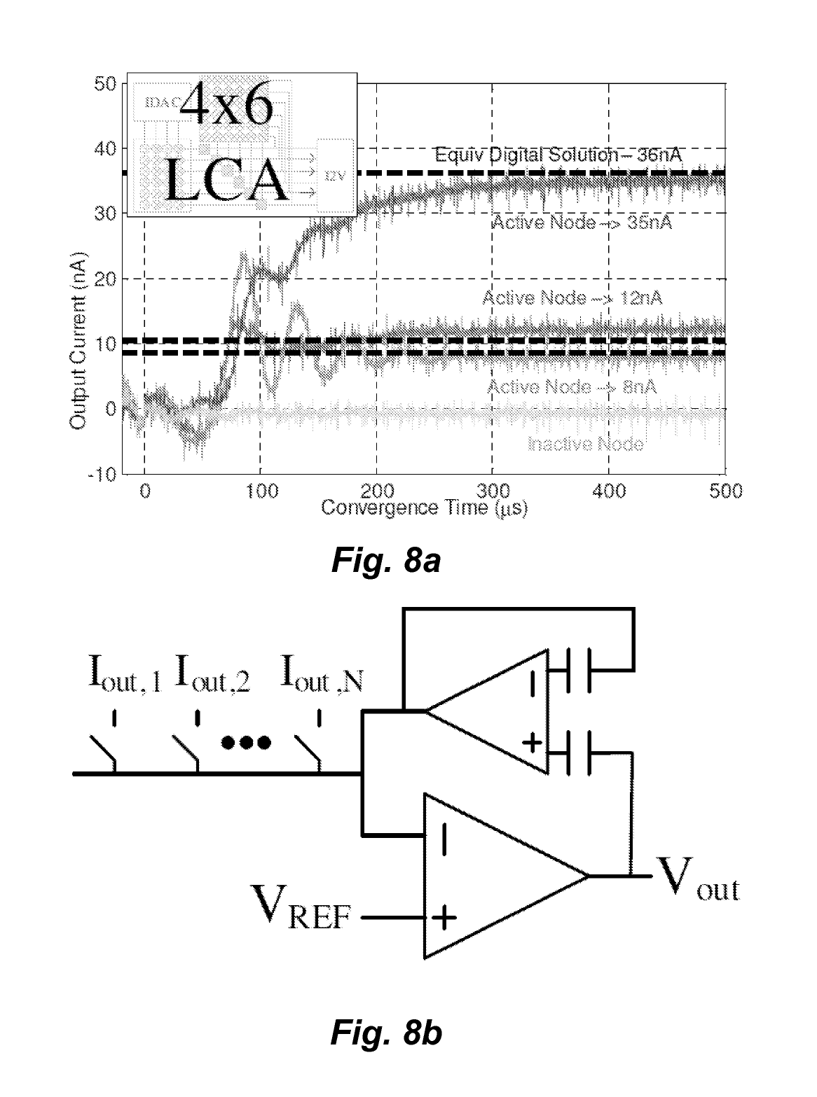

Each soft threshold node can be implemented with multiple output transistors. A first can be used to drive the rest of the circuit. A second can be used as a system output. As shown in FIG. 8b, the output currents can be scanned out by the volatile switch lines and, in some embodiments, then sent to an on-chip 12V current-to-voltage converter for rapid measurement. In other embodiments, a picoammeter can be used for debugging the circuit and calibrating the voltage.

Using the dynamical switches, both individual components and the complete can be easily tested. In some embodiments, on-chip current DACs can be used to inject currents with a constant l²-Norm into the circuit. For the 2×3 network, the input can be swept on the unit circle. For the 4×6 network, 100 randomly generated inputs can be used. For both systems, the input currents, the outputs of the feedforward VMMs (with and without thresholding), the outputs of the recurrent VMMs, and the system outputs can be separately measured. FIGS. 2b-2d illustrate the progression of these results for the 2×3 network.

Accuracy of Results

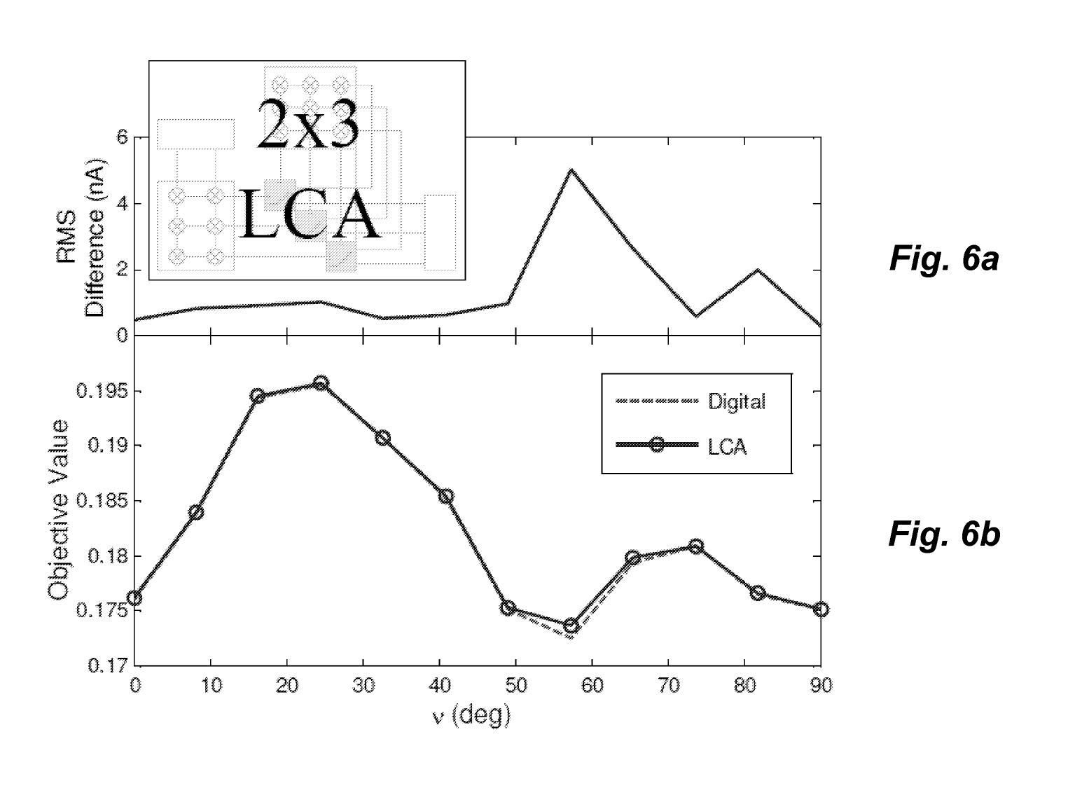

In order to verify the accuracy of the analog LCA, the inputs can be run through 11-1s, a known digital sparse approximation algorithm. For both the 2×3 and 4×6 systems, the solution produced by the hardware network was very similar to that produced by the digital solver. As shown in FIG. 6a, for the smaller network, the root-mean-square (RMS) difference of the analog and digital solutions was at maximum 5.1 nA and averaged less than 1 nA, or less than 2% of the magnitude of the input. The larger network showed slightly higher divergence, with a max RMS difference of 9.2 nA, or 15.3%, and an average RMS 2.9 nA, or 4.8%.

As shown in FIG. 6b, despite some deviation from the digital solution, the large network converged on a moderately optimized sparse code. The final value of the objective function averaged only 1.3% higher for the 4×6 network than for the 11-1s solution, and in the worst case was only 3.2% higher. Most of the increase in the objective function in the analog solution came from the MSE term, which averaged 4.6% higher than in the digital case. The average l₁-Norm was virtually identical for both analog and digital solutions. In addition, the support vector of the analog system (the list of active nodes) was identical to that of the digital solution in 63 of 100 trials, and never differed by more than one node.¹ ¹Matching the support set is an important achievement, since the optimal sparse approximation solution can be fully recovered if the correct support set is identified.

Power and Scaling

The power used by the RASP 2.9 v implementation of the LCA is dominated by two terms: (1) overhead—703 μA is used by the FPAA even without programming and (2) 20 μA for the high speed current-to-voltage converter. The remainder of the current flow can be accounted for with the OTAs, since every source to sink path in the LCA passes through at least one OTA. The OTAs are differential pairs with a double current mirror, so they naturally use twice their bias current regardless of any sourcing or sinking any current. Because every signal in the LCA chip sinks to an OTA, however, all the active currents in the chip can simply be summed to find the total additional power used.

Each VMM input requires an OTA. In addition, each current mirror for the inputs requires an OTA (and they sink twice the input current). The soft thresholder requires two OTAs, and sinks twice the lateral inhibition Ha, twice the threshold current λ, and twice the output a. The total current used by the system is therefore:

$${I}_{TOT} = ( M + N ) ( 2 {I}_{V} ) + ( M + 2 N ) ( 2 {I}_{M} ) + 2 {‖ y ‖}_{1} + 2 {‖ Ha ‖}_{1} + 2 N λ + 2 {‖ a ‖}_{1} , \qquad ( 6 )$$

where I_{V} is the bias current of the VMM OTAs, and I_{M} is the bias current of the mirror OTAs.

In both of the 2×3 and 4×6 networks, I_{M} was set to 500 nA. This current was sufficient to sink three 60 nA currents (the third being used only when the node is directly measured) while maintaining a high OTA transconductance. I_{V} was also set to 500 nA in the 2×3 network, and to 800 nA in the 4×6 network.

Excluding overhead, therefore, the active circuits of the 2×3 LCA had a total current of 11.8 μA, with small variations depending on the signals being passed. This is actually slightly less than the 13 μA that would be expected from Eq. 6. Similarly, the total power use of the 4×6 system was only 31.1 μA, which is also somewhat less than the 32 μA predicted by Eq. 6. These discrepancies are most likely due small inaccuracies in the bias current programming. As discussed below, the OTAs must have a bias current large enough to sink or source all the appropriate currents while maintaining a high transconductance.

Temporal Evolution of the System

FIG. 8a depicts the evolution of the 4×6 LCA for a typical input. The temporal evolution of the analog LCA can be measured by sending the current-mode outputs through a fast current-to voltage converter, which can then be sent to a high speed oscilloscope. Each relevant node can be measured in this way. The time courses following the setting of the current DACs can then be superimposed. Experimentally, the outputs settled to within 1 nA RMS of their final values in 240 μs.

The convergence curves varied considerably from predicted LCA dynamics. Theoretical analysis and simulations of the LCA's temporal evolution show exponential convergence for active nodes in less than 10τ. The theoretical upper bound on convergence time, on the other hand, is proportional to τ/γ, where τ is the RC time constant, and γ is the smallest eigenvalue of the active subspace of the matrix Φ (i.e., the same term that determines error amplification above).

As shown in FIG. 8a, however, purely exponential convergence was not observed experimentally. Rather, there is a delayed start and decaying oscillations that eventually converge on a solution. The slow ramp time likely results from the dynamics of the current minor circuit used in the thresholder, which is not a simple RC filter when the current is low.

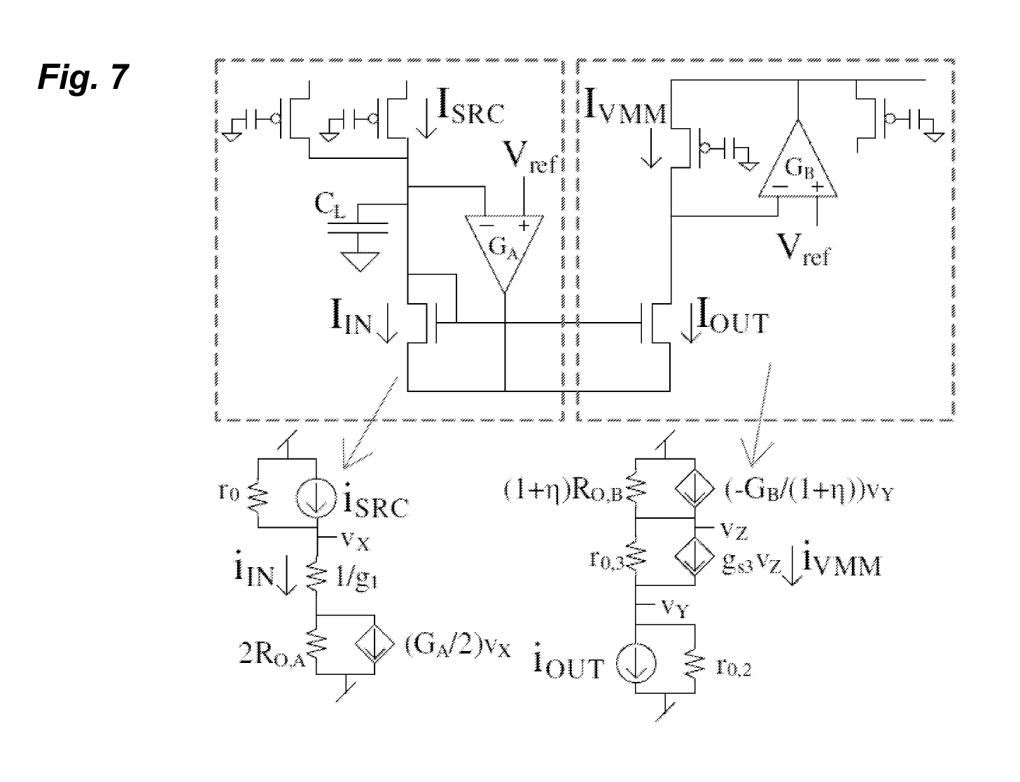

The input resistance R can be derived from the small signal model (shown in FIG. 7) as:

$$R = {r}_{0} ‖ \frac{1 / {g}_{1} + 2 {R}_{0 , A}}{1 + {G}_{A} {R}_{0 , A}} \approx σ \frac{{U}_{T}}{κ {I}_{IN}} + 2 \frac{{U}_{T}}{κ {I}_{A}} \qquad ( 7 )$$

For small I_{IN}, the first term dominates, and the system dynamics approach:

$$\frac{{C}_{L} {U}_{T} σ}{κ} \frac{\cdot {I}_{IN}}{{I}_{IN}} + {I}_{IN} = {I}_{SRC} . \qquad ( 8 )$$

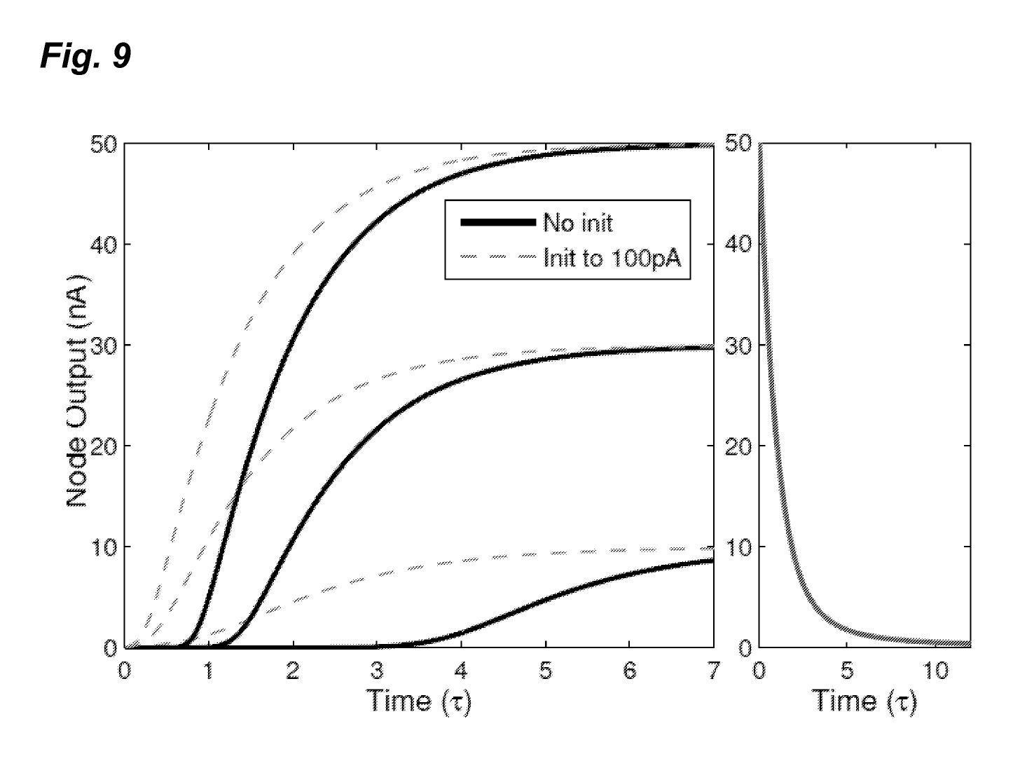

These dynamics are depicted in FIG. 9. Initializing all system inputs to zero ensures that all nodes will start at zero. This initialization prevents the slow decay that would be required if a signal changed, for example, from 50 nA to 0 nA. Unfortunately, these dynamics still impose relatively long startup latency while the input node voltage is charged. In some embodiments, therefore, this latency could be mitigated by initializing the nodes to a higher value (e.g., 100 pA in FIG. 9).

For I_{IN}>I_{A}σ/2≈3 nA, the second term in Eq. 7 dominates, and the system acts as a low pass filter with RC time constant τ=2C_{L}U_{T}/(κI_{A}). To make this the dominant pole in the LCA system, the load capacitance C_{L} can be made extremely large—e.g., higher than 50 pF—by shorting it to a chip pad, for example. The capacitance, on the other hand, could be reduced to approximately 2-3 pF (i.e., the capacitance of a vertical routing wire) at the cost of slightly altering the LCA dynamics. In some embodiments, this could speed up convergence times by a factor of 10 or more.

In addition to the approximately 240 μs required for convergence, each 8-bit input DACs takes approximately 5.8 μs to load and reading an output node requires 520 ns adding about 26 μs for interfacing. These costs are imposed by the microcontroller, however, and are not inherent to the RASP 2.9 v.

As the system scales, we would expect the convergence time is expected to scale with the time constant τ=2C_{L}U_{T}/(κI_{A}). In this equation, only the load capacitance C_{L} will increase with scale at roughly O(N). Because C_{L} is already much larger than necessary, however, a custom built large N implementation would actually be expected to converge more quickly.

### Spiking Solutions for Sparse Computing

Sparse approximation has recently been suggested as a model for sensory coding in the human brain, according to the hypothesis that the brain attempts to make efficient use of computational resources.² In the sparse coding model for the primary visual cortex, for example, a small subset of learned dictionary elements can encode most natural images.³ This sparse basis is mapped directly to neural activity, so only a small subset of the cortical neurons need be active to represent the high dimensional visual inputs. As discussed above, sparse approximation can also be used to recover linearly compressed signals for compressed sensing applications. ²See, e.g., H. B. Barlow, Possible principles underlying the transformation of sensory messages, in: W. Rosenblith (Ed.), Sensory Communication, M.I.T. Press, Cambridge Mass., 1961.³See, B. Olshausen, D. Field, Emergence of simple-cell receptive field properties by learning in a sparse code for natural images, Nature 381 (1996); B. Olshausen, M. Lewicki, et al., Sparse codes and spikes, Probabilistic Models of the Brain: Perception and Neural Function (2001).

Impact of a Spiking Implementation

Inspired in part by the brain's extreme computational efficiency and by recent advances in implementing neurons in silicon, in some embodiments, a spiking neural network can be used for solving sparse approximation problems. This approach has several benefits relative to both the digital and the non-spiking analog methods described above.

As discussed above, an analog system offers considerable power savings relative to digital solutions for the portions of the optimization that rely on linear computation. Analog vector-matrix multipliers (VMMs), for example, are several orders of magnitude more computationally efficient than comparable digital multipliers. The power in these systems is proportional to the maximum possible signal; however, and in a system where the output is expected to be sparse this can be wasteful, since few signals will be nonzero.

As a result, in some embodiments, a rate-based spiking system can be used to leverage the sparsity of the signals. In other words, by following the lead of the sparse neural coding activity and mapping the sparsity of the input to neural activity, both the number of spiking neurons and their spike rates can be minimized. This, in turn, minimizes total power consumption, since synapses only consume power when they spike.

A spiking system could be used, for example and not limitation, for compressed sensing applications. Compressed sensing has led to the design of new coded aperture sensing systems that, for example, require many fewer measurements to collect data at a specified resolution. A spiking system could be used to recover the compressed signal very quickly, however virtually eliminating the post-processing that has become the accepted bottleneck (e.g. in medical imaging). Alternatively, the spiking system could be optimized for low power, allowing compressed sensing techniques to be used for channel sensing in portable devices where power concerns outweigh processing speed.

### Description of the Neuronal Architecture

As discussed above, the LCA is described by a system of nonlinear ordinary differential equations (ODEs). In order to convert it to a spiking system each component of the system can be analyzed to find neuronal equivalents.

Converting LCA to a Spiking Architecture

To create a spiking network, ideal Integrate and Fire (IF) Neurons can be used to compute the nonlinear portions of Eq. 4, above. A stochastic rate model of the neurons can be used, for example, and spikes can be generated using an instantaneous spike rate (or intensity) depending on the time-varying input to the neuron. The intensity of the entire population of neurons â(t) can be used to encode the system output.

The gain function of the IF neurons, for example, can be derived by analyzing the

normalized neural potential

$$v ( t ) = \frac{V - {V}_{0}}{{V}_{TH} - {V}_{0}}$$

as a function of the normalized current input

$$u ( t ) = \frac{{I}_{IN}}{C ( {V}_{TH} - {V}_{0}} ,$$

where V_{TH} and V₀ are the threshold and reset potentials of the neuron, and C is its capacitance.

\dot{v}(t)=u(t),v(t⁻)>1→v(t⁺)=0, spike (9)

When the voltage reaches the threshold (v(t)=1), therefore, the neuron emits a spike at that time and resets the voltage. Of course, the neuron will only spike if the input is positive, which means that the neuron conveniently acts as a natural rectifier. The inter spike interval (ISI) at steady state will be approximately 1/u, and the intensity â(t)=max (u(t),0). By adding a small negative offset λ to the input current, Eq. 10 becomes:

\dot{v}(t)=u(t)−λ,v(t⁻)>1→v(t⁺)=0, spike, (10)

and the firing rate becomes,

â(t)=max(u(t)−λ,0)=T_{λ}(u(t)), (11)

which is the soft threshold operator used in the LCA.

The linear portion of the network can be generated with synaptic connections. These synapses have a linear response to each incoming spike, the kernel α(t)=U(t)e^{-t/τ}, where U(t) is the Heaviside step function, and τ is the synaptic time constant. The synapses can be arbitrarily weighted and their outputs can be shorted together (i.e. their currents can be summed via Kirchoff's Current Law), enabling the recurrent matrix Φ^{T}Φ−I to be created. The normalized input to neuron i can then be set to:

$${u}_{i} ( t ) = {b}_{i} - {\sum }_{j \neq i}^{ } ( {H}_{ij} {\sum }_{k}^{tj , k < t} α ( t - {t}_{j , k}^{FB} ) ) , \qquad ( 12 )$$

where b=Φ^{T}y is the driving input, H=Φ^{T}Φ—I, and t_{j,k}^{FB} is the kth spike time of neuron j. By randomizing the initial states of the neurons, the normalized expectation of neuron j producing a spike at time t as the instantaneous rate âⱼ(t), or intensity, can be defined. The expectation, E[uᵢ−(t)], can be defined as

$$E [ {u}_{i} ( t ) ] = {b}_{i} - {\sum }_{j \neq i}^{ } ( {H}_{ij} ( α ( t ) * E [ {\hat{a}}_{j} ( t ) ] ) ) , \qquad ( 13 )$$

A Laplace transform of both sides can be performed, then divided by the filter, α(s)=1/(1+sτ). Performing the inverse Laplace transform then yields:

$$τ \frac{d}{d t} E [ {u}_{i} ( t ) ] + E [ {u}_{i} ( t ) ] = {b}_{i} - {\sum }_{j \neq i}^{ } ( {H}_{i , j} E [ {\hat{a}}_{j} ( t ) ] ) , \qquad ( 14 )$$

converting to matrix form gives:

$$τ \frac{d}{d t} E [ u ( t ) ] + E [ u ( t ) ] = {Φ}^{T} y - ( {Φ}^{T} Φ - I ) E [ \hat{a} ( t ) ] . \qquad ( 15 )$$

Eqs. 11 and 15 can then be combined to create the spiking LCA system:

$$\begin{matrix}τ \frac{d}{d t} E [ u ( t ) ] + E [ u ( t ) ] = b - ( {Φ}^{t} Φ - I ) E [ \hat{a} ( t ) ] , \\ E [ \hat{a} ( t ) ] = E [ {T}_{λ} ( u ( t ) ) ] \approx {T}_{λ} ( E [ u ( t ) ] )\end{matrix} . \qquad ( 16 )$$

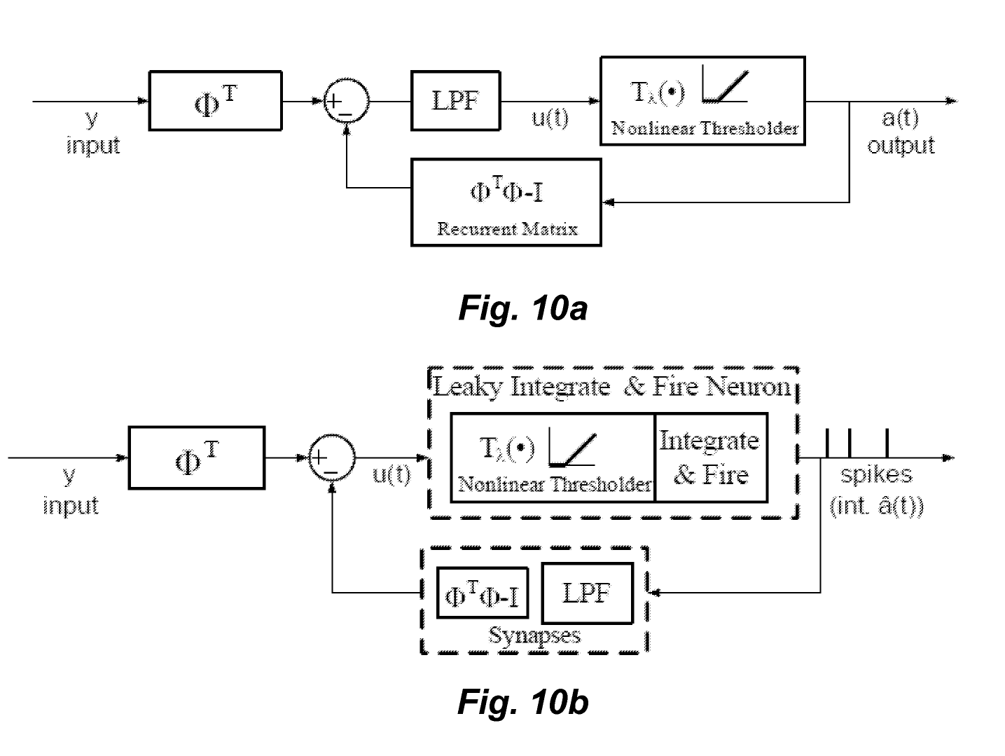

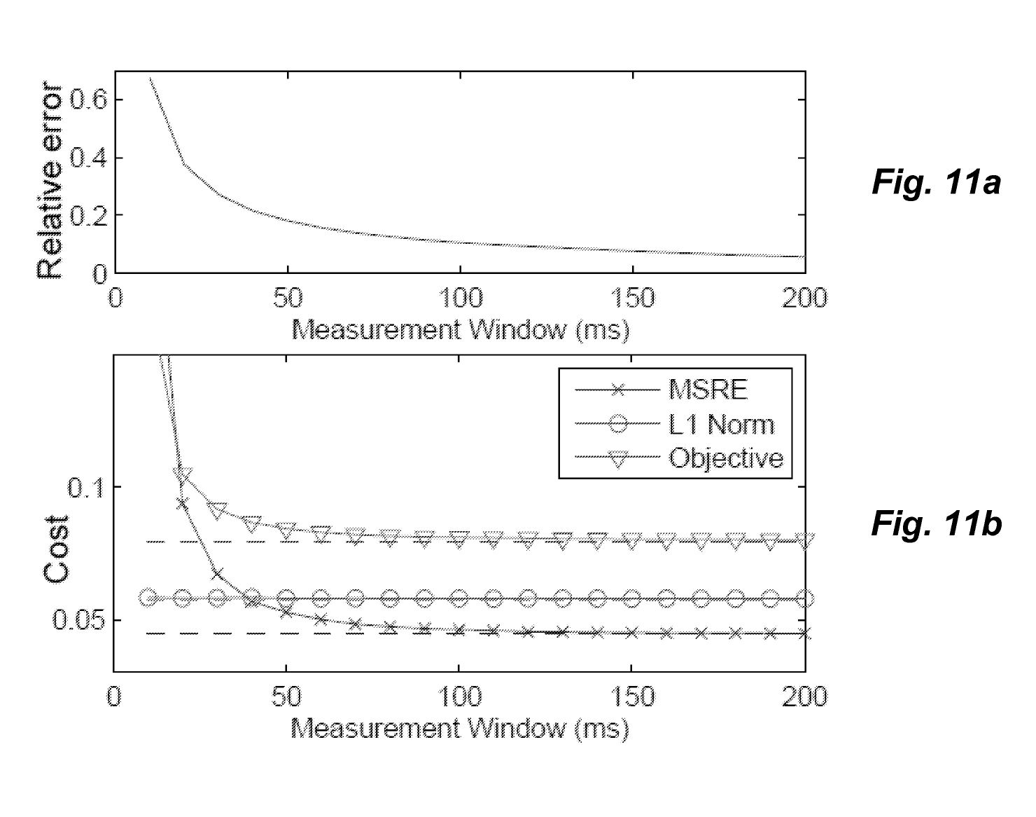

An example of a particular spiking LCA system is shown in FIG. 10b and compared to the non-spiking LCA (FIG. 10a), described above. In this system, the expected value of the spiking intensities E[â(t)] is expected to converge to the solution of the BPDN problem in Eq. 10. See, FIG. 11a. E[â(t)] cannot be directly observed, but it can be estimated by finding the average spike rate in some fairly long time window t_{w}. In other words, if t_{w} is sufficiently large, then by the law of large numbers our average should converge to the expected value of the instantaneous spike rate. As shown in FIG. 11b, the spiking LCA can find solutions comparable to a digital BPDN solver, in this case, the l₁-Regularized Least Squares (L1-LS) algorithm.

### Hardware Implementation

System Components

In order to implement a dense spiking LCA on the same RASP 2.9 v used above, the design can be limited to using the available CAB elements of the chip.

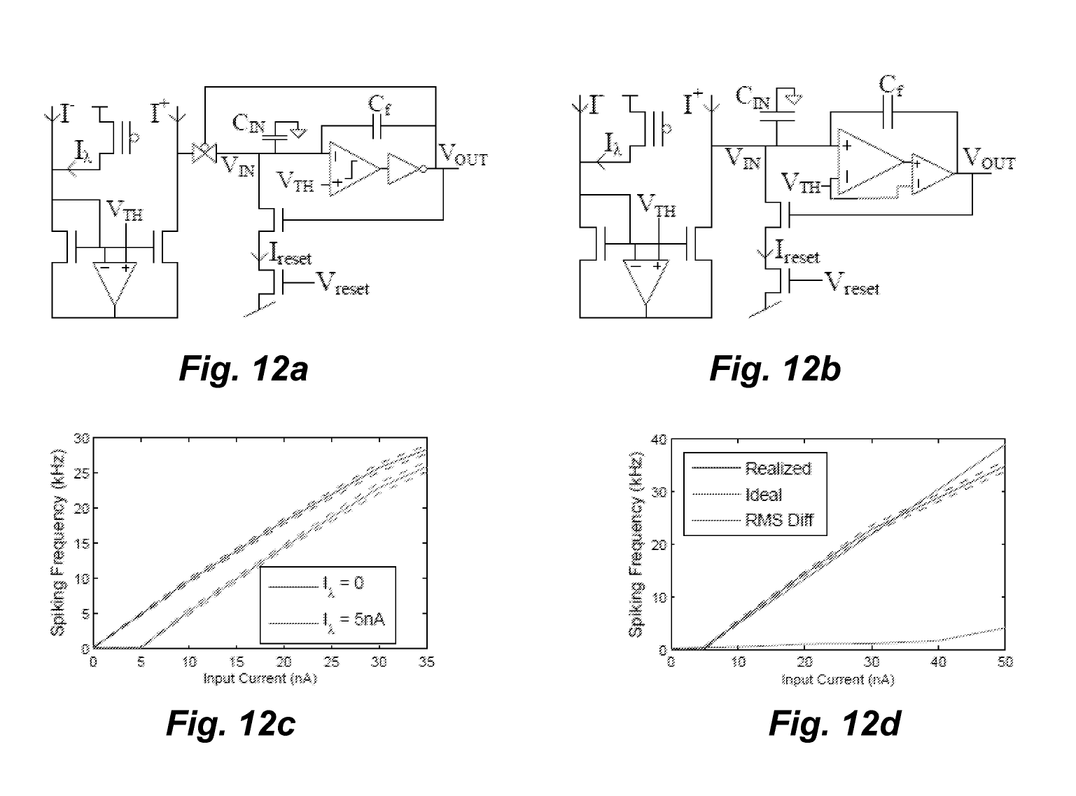

The most complex system component, based on the Axon-Hillock circuit shown in FIG. 12a, is the integrate and fire neuron. The neuron can begin with a drain matched current minor, which can accept inhibitory currents from synapses I⁻ and threshold current I_{λ} and subtract it from the excitatory currents I⁺ from the VMM. The resulting net current I_{IN} can charge the potential on the implicit capacitance C_{IN}V_{IN}=I_{IN} until the comparator senses that V_{IN} has exceeded the threshold potential V_{TH}. As the output of the comparator V_{OUT} increases, it raises V_{IN} via feedback capacitor C_{f}, providing hysteresis to the comparator. In addition, the reset current will be triggered, pulling down V_{IN} until it reaches V_{TH}. The feedback then pulls V_{IN} down.

The feedback produces a change of roughly

$${V}_{DD} \frac{{C}_{f}}{{C}_{IN} + {C}_{f}} \approx$$

on V_{IN}. In order to ramp back up to V_{TH} and produce a spike, therefore, I_{IN} needs to produce a charge of

$${Q}_{RAMP} = {V}_{DD} \frac{{C}_{1} {C}_{f}}{{C}_{1} + {C}_{f}} \approx {V}_{DD} {C}_{f} .$$

On the RASP 2.9 v, for example, the smallest explicit capacitors are 500 fF, and V_{DD}=2.4V. This leads to a ramp time of: t_{RAMP}=Q_{RAMP}=I_{IN}=1.2 pC/I_{IN}.

In a preferred embodiment, the neurons would have a fixed refractory period while the voltage was reset. In this case, however, the RASP 2.9 v has insufficient transmission gates to cut off the incoming current during reset at the desired density. In response, the circuit shown in FIG. 12b can be implemented. This circuit produces a reset time of t_{RESET}=1.2 pC/(I_{REsET}−I_{IN}). Combining these times and the latency of the comparator t_{LAT} produces a period of:

$$\begin{matrix}{T}_{IF} = {t}_{RAMP} + {t}_{RESET} 2 {t}_{LAT} \\ = \frac{1.2 pC}{{I}_{IN} ( 1 - {I}_{IN} / {I}_{RESET} )} + 2 {t}_{LAT} .\end{matrix} \qquad ( 17 )$$

FIG. 12c shows the results of the circuit as implemented on the RASP 2.9 v. The current to frequency (FI) curve corresponds to I_{RESET}≈400 nA and t_{LAT}≈4 μs. In this configuration, the spiking LCA utilizes the FI filter as an ideal soft-threshold. In practice, this can limit the input range to approximately 40 nA, i.e., a region where the response of the neuron is substantially linear. See, FIG. 12d.

The IF Neuron can utilize 4 explicit nFETs. On the RASP 2.9 v, for example, there are 18 CABs that contain at least four, which effectively limits the density of the system in this configuration to 18 neurons. The synaptic grids can perform the operation τh(t)+h(t)=Hâ(t) to compute the recurrent inhibition. As before, the feedback mechanism is similar to that of a Hopfield Network. In other words, there is no feedback from one node to itself (H_{i,i}=0) and the feedback between nodes is symmetric (H_{i,j}=H_{j,i}).

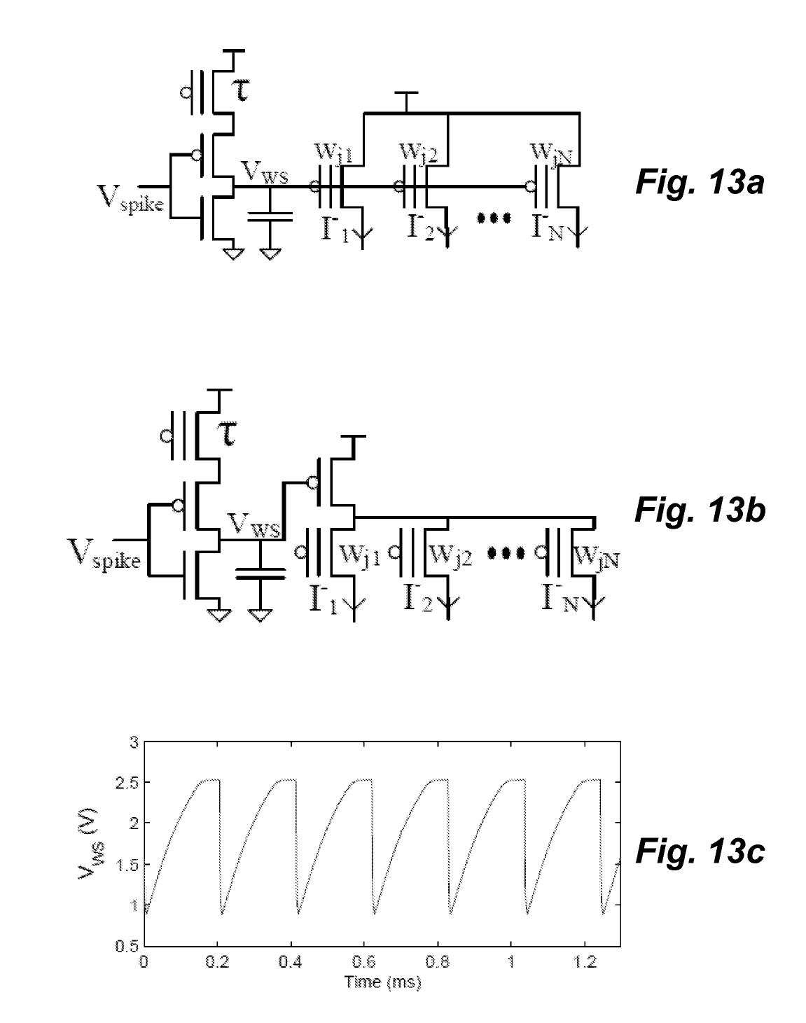

As shown in FIGS. 13a and 13b, the synapses can be thought of as two circuits: a wave shaping circuit and a matrix of synaptic weights, with one wave shaping circuit per Neuron. After each spike, a current starved inverter produces a sawtooth wave, the slope of which determines the synaptic time constant τ (FIG. 13c). Ideally, as shown in FIG. 13a, this sawtooth wave would be attached to the gates of the synapses to produce a current that would decay exponentially from the programmed current of the FGEs. Each individual synapse requires only a single floating gate transistor, whose floating gate charge represents the weight of that synapse. The outputs of the synapses with the same postsynaptic neuron can then be shorted together to produce the inhibitory current I⁻ for that neuron.

Because the gates of the FGEs are not locally accessible, however, the topology shown in FIG. 13b can be used. This topology creates a non exponential decay based on the drain current passed by the supply pFET and capacitive coupling from the source to the floating gates of the synapses, both of which are subject to mismatch. This mismatch can be overcome, however, using a calibration routine to accurately program their weights.

A VMM can act as the feedforward multiplier, performing the linear operation b=Φ^{T}y. Experimentally, this multiplication was performed digitally and directly projected the current I⁺ from the 18-8 bit current DACs to the positive input terminals of the neurons. There are several circuits on-chip, however, that could be used to perform the multiplication. One example is a current mode VMM structure.⁴ This configuration has a small area, low power consumption, an easily scalable design while operating in the sub-threshold region, and fits easily on the RASP 2.9 v. ⁴See, e.g., C. Schlottmann, P. Hasler, A highly dense, low power, programmable analog vector-matrix multiplier: The FPAA implementation, 1 IEEE J. on Emerging and Selected Topics in Circuits and Systems 3, 403-411 (2011); S. Shapero, P. Hasler, Precise programming and mismatch compensation for low power analog computation on an FPAA, IEEE Trans. Circuits and Systems I, in press (both of which are incorporated herein by reference).

In some embodiments, the charge on each FGE can be programmed to set the weight of each scalar multiplication. A current mode VMM, for example, can accept the input vector y from the current DACS and perform the operation b=Φ^{t}y to compute the driving inputs to the neurons. Power consumption with this configuration is proportional to O(N\sqrt{N}) with the number of output nodes, however, which is not ideal. In alternative embodiment, the VMM component can be implemented as a synaptic matrix like the recurrent multiplier. In this configuration, the spikes to drive the synapses are preferably generated on-chip. This could be accomplished, for example and not limitation, either by another bank of neurons or by spike generation circuits.⁵ ⁵See, e.g., J. Schemmel, D. Brüderle, K. Meier, B. Ostendorf, Modeling synaptic plasticity within networks of highly accelerated I&F neurons, IEEE International Symposium on Circuits and Systems (2007); S. Brink, S. Nease, S. Ramakrishnan, R. Wunderlich, P. Hasler, A. Basu, B. Degnan, A learning-enabled neuron array IC based upon transistor channel models of biological phenomena, Accepted to IEEE Trans. in Biomedical Circuits and Systems (both of which are incorporated herein by reference).

### Example 2

To test the configuration described above, a network of 18 neurons, with 12 driving inputs, can be implemented on the RASP 2.9 v. This network enables the solution of BPDN for arbitrary 12×18 dictionaries of non-negative elements.

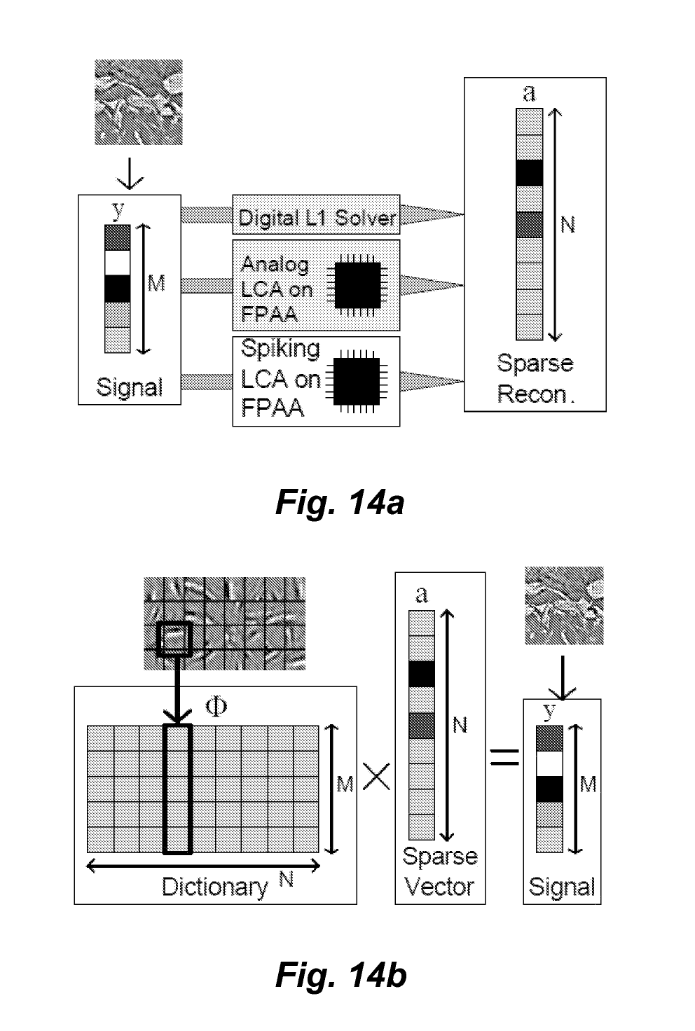

In addition to the components discussed above, an on-chip 8-bit current DACs can be used to inject vectors of currents onto the chip. See, FIG. 14a. As shown in FIG. 14b, in this case, the input vectors were created via the assumed generative model for sparse signals: a basis set of fixed sparsity (k=1−4) was multiplied by the dictionary Φ. The use of feedforward VMM to generate these results was not used. Instead, the feedforward multiplication was performed digitally and then directly applied to the neurons via the current DACs. The threshold current, Iλ, was implemented at multiple values 2.5 nA and 5 nA, illustrating the tradeoff between accurate reconstruction (i.e., low Iλ) and better enforced sparsity (i.e., high Iλ).

Many of the nodes in the neurons required calibration. This is easily accomplished, however, using volatile switch lines to pass outputs to onboard ADCs and a picoammeter to measure voltages and currents, respectively. Conveniently, the volatile switch lines can also be used to process the system output. In other words, the spikes can be passed to a rapid ADC and the number of spikes in a 1 ms window, for example, can be counted and used to calculate a spike rate for each neuron. The solution to the sparse approximation problem was proportional to these spike rates (43 kHz:50 nA).

### Results of the Fully Implemented System

The system can be validated by running trials for each sparsity. For k=1 and k=2, 18 and 135 trials, respectively, were sufficient to exhaust the possible basis sets and vary the relative magnitudes of the components. For k=3 and 4, 200 randomly chosen basis vectors with random values for each component can be used. To assess the accuracy of the spiking solutions, they can be compared to a digital solution derived via an L1-LS algorithm.⁶ ⁶S.-J. Kim, K. Koh, M. Lustig, S. Boyd, D. Gorinevsky, A method for large scale 11-regularized least squares, 1 IEEE Journal on Selected Topics in Signal Processing 4 (2007).

Analysis of Results

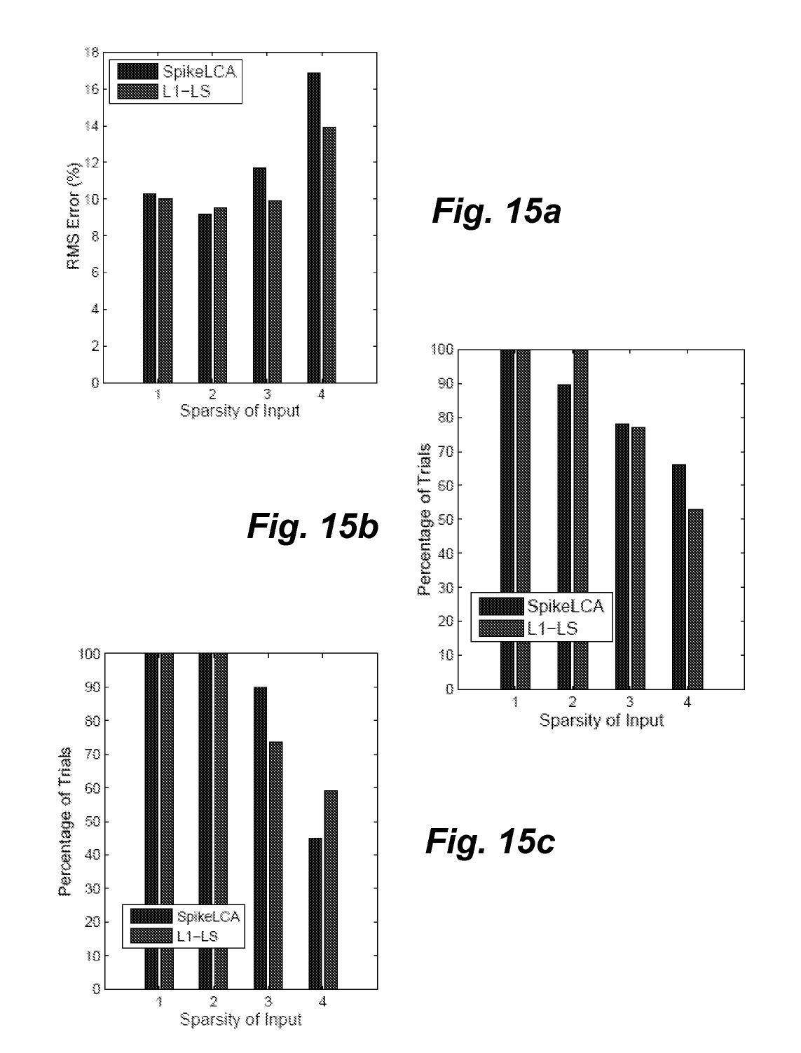

As before, there are several ways of quantifying the performance of a sparse approximation system. For compressed sensing systems, for example, the goal is to recapture the sparse vector that was used to generate the input. As shown in FIGS. 15a-c, for k=1 and 2 and Iλ=5 nA, the spiking LCA was able to successfully find the basis set that had generated the input in every trial, as was the L1-LS digital algorithm. For k=3, the LCA found the basis set in 180 out of 200 trials. Significantly, this outperformed the digital algorithm, which only identified the basis set in 147 trials. See, FIG. 15c. As shown in FIG. 15b, changing to Iλ=2.5 nA reduced the identification rate for k=2 and 3, but had the benefit of reducing the rMSE by half. For k=1 and 2, the spiking and digital solutions had comparable reconstruction of the sparse components. Decreasing Iλ further, for example, would further reduce the RMSe of both the digital and spiking solutions, until the noise floor is reached. This floor could be from, for example and not limitation external sources or errors in the spiking implementation.

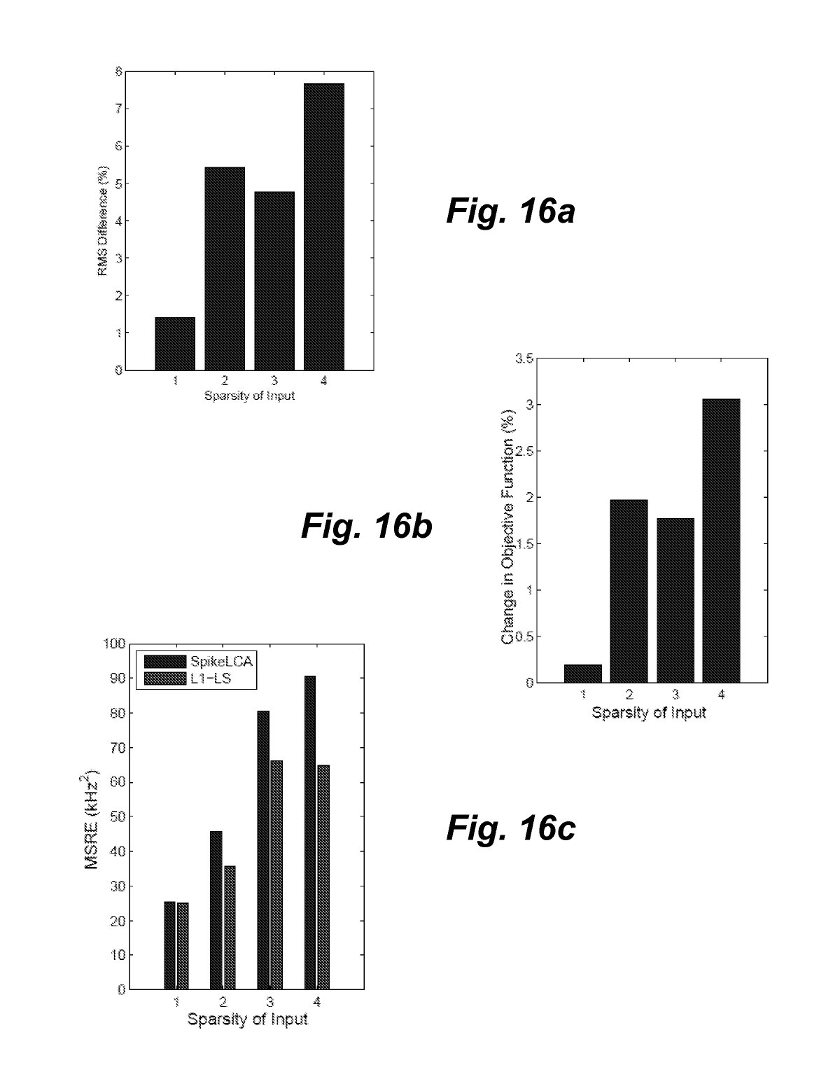

As shown in FIG. 16b, in terms of the actual objective function (shown in Eq. 3), the digital solution generally found a lower cost solution than the spiking LCA. This is logical because, as mentioned above, the hardware implementation includes a number of errors and deviations from an ideal LCA. These variations can cause the system to depart from the optimal solution. As shown in FIG. 16a, when Iλ=2.5 nA, for example, these differences were generally small. For k<=3, the spiking LCA found a solution with an RMS difference of less than 2 spikes (2 kHz) from the digital solution. For k=3, this difference is 4.8% of the l₂-Norm of the digital solution. At k=4, the spiking solution started to diverge significantly from the L1-LS solution.

It should be noted, however, that at k=4 the digital algorithm was also identifying the correct basis set in less than 60% of the trials. In addition, with a 12 dimensional input generated from 4 dictionary elements, it is debatable as to whether the input could still be considered sparse. As shown in FIG. 16c, increasing Iλ to 5 nA essentially doubles the error of the solutions, but also increases the identification of the proper basis set. For k=2, for example, the basis set was completely identified.

System Dynamics and Performance

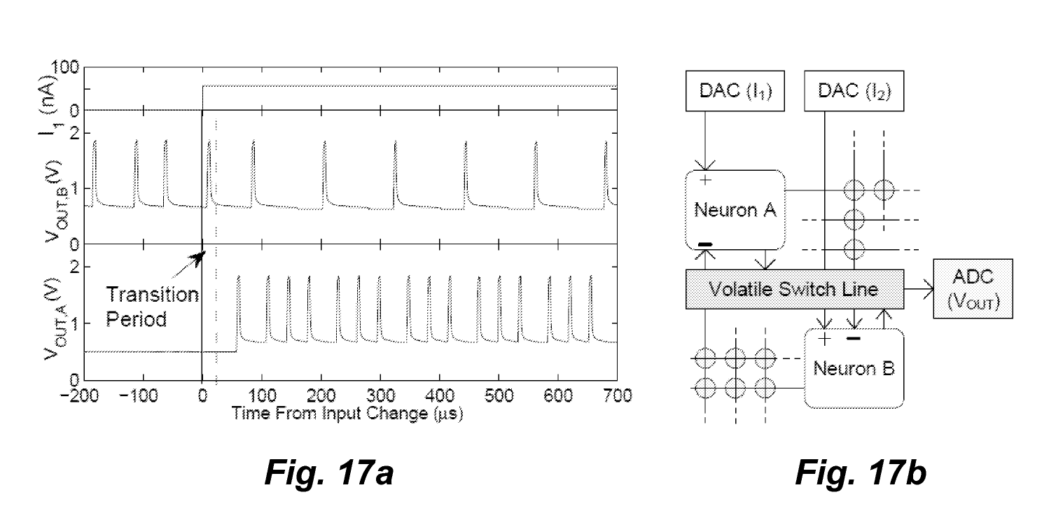

Using the experimental setup herein, only one neuron can be recorded at a time. As a result, the same trial was run multiple times to measure the dynamics of the entire system. The results of one such exemplary trial are shown in FIGS. 17a and 17b. At the beginning of the experiment, the input has a sparsity of k=2. At t=0, the input is modified to have an additional component, which excites an additional neuron sufficiently to cause it to spike. As shown, the spikes from the newly excited neuron quickly inhibited the other active neurons sufficiently to slow their rate of spiking. Within 25 μs the system has evolved to its final state. This can be observed in two ways: (1) the ISIs are regular from this point forward, and (2) any spike count measurement window that begins after this point will show no error from the transition.

This rapid convergence indicates that the actual speed of computation is dominated by the measurement time. From both simulations (FIG. 11) and experimental data, the RMS quantization error is shown to be inversely proportional to the length of the measurement window t_{w}, and is 1/(t_{w}\sqrt{6}) for each active neuron. For a rate encoded system, therefore, this trade-off cannot be reduced. By increasing the maximum possible spike rate, however, the relative quantization error can be decreased.

The spike rate could be measurably improved by moving to a more custom architecture, instead of the RASP 2.9 v. The chip, while convenient for experimental purposes, has significant interconnect capacitances (about 1 pF), that could be eliminated with a custom chip. The custom 180 nm Spikey chip, for example, includes an array of over 300 neurons capable of firing at over 5 MHz.⁷ Leveraging these firing rates, a measurement window of 10 μs would give approximately the same relative quantization error seen here. ⁷J. Schemmel, D. Brüderle, K. Meier, B. Ostendorf, Modeling synaptic plasticity within networks of highly accelerated I&F neurons, in: IEEE International Symposium on Circuits and Systems, 2007.

Power

The spiking LCA uses approximately 3 mW of power, or 1.26 mA at 2.4 V. Up to an additional 10 μA of current draw was observed depending on the output. As before, the majority of this power comes from chip overhead (the RASP 2.9 v drains approximately 703 μA of current even when nothing is programmed). When none of the neurons spike, the rest of the power is consumed by the OTAs in the neurons. Of the 559 μA used, the vast majority, or 502 μA, is consumed by the second OTA in the comparator of the IF neurons. See, FIG. 12b. Replacing these 18 elements with digital inverters (as shown in the ideal circuit FIG. 12a), for example, and a digital buffer to take the signal off-chip would eliminate this current component entirely. This would come at the cost of less than 1 μA of active power when firing at 80 kHz.

The remaining 57 μA, or 3.2 μA per neuron, is divided evenly between the other OTAs. The first OTA is part of the active current minor in FIG. 12b. The current mirror circuit in FIG. 12a would dramatically reduce this power consumption if additional nFETs were available because the OTA would no longer need to sink I⁻. The comparator OTA, on the other hand, cannot be eliminated, and its power is a function of how fast the second stage of the comparator is driven. In other words, based on the above, significant additional efficiencies can be achieved through the use of a custom chip.

Scaling

With 18 neurons, the spiking LCA is scaled to the maximum extent on the RASP 2.9 v (i.e., the chip has 36 regular CABs, and each neuron requires 2). Indeed, the system described herein uses over 1400 of the floating gates, representing the largest system synthesized on a RASP chip to date.

Further scaling is required, however, to meet even the most basic requirements for sparse coding applications. This can be achieved with a more customized chip with dedicated synaptic and neural circuitry. In order to reach a size of 1000 neurons, for example, the chip would contain over one million synapses. Fortunately, as discussed above, this is easily implementable using current technology.

The power benefits of the LCA increase as the system becomes larger. Replacing the second stage of the comparator with an inverter (as in FIG. 12a), for example, reduces the power consumption to 3.2 μA per neuron, which compares favorably with the non-spiking LCA (5 μA per node). In addition, while the power consumption of the spiking LCA scales linearly with the number of neurons, the non-spiking LCA scales O(N\sqrt{N}). If the systems were scaled to 1000 output nodes each, for example, the spiking LCA would consume approximately 2% the power of the non-spiking system. The two hypothetical systems are compared in Table 1.

TABLE 1
Performance Comparison

| | System | | | | | | | |
|---|---|---|---|---|---|---|---|---|
| | | | 666 × 1k | | 666 × 1k | | | |
| | 12 × 18 | | Spiking LCA | | Analog LCA | | 1k CPU | |
| | Spiking LCA | | (Hypothetical) | | (Hypoth.)[4] | | [3] | |
| Power (Active) | 1.34 | mW | 7.68 | mW | 149 | mW | ≈3.8 | W |
| (Total) | 3.02 | mW | 9.79 | mW | 151 | mW | ≈100 | W |
| Time (Converge) | 25 | μs | ≈25 | μs | ≈240 | μs | 46 | ms |
| Time (Total) | 1.03 | ms | 1.03 | ms | 4.62 | ms | 46 | ms |

| | | | | |
|---|---|---|---|---|
| Error (RMS) | 4.8% (@ K = 3) | ≈4.8% | ≈5% | — |
| Extra Cost (Avg) | 1.7% (@ K = 3) | ≈1.7% | ≈1% | — |

In addition, accuracy is expected to remain substantially the same as system size increases. Relative quantization error, for example, is independent of size and synchronization errors should actually decrease as the number of active neurons increases. Similarly, gain error should marginally decrease as a larger dictionary better respects the RIP. Additionally, as shown in FIG. 13a, a customized system drives the gates of the synapses rather than their source, further reducing gain error.

Up to N=1000, the convergence time is not expected to increase. This is because the convergence time scales with the LCA time constant, which here is equivalent to the synaptic time constant. We would not expect time constant to meaningfully increase because the load capacitor of the synapses already spans the length of the chip. As a result, this distance cannot be larger. Similarly, the measurement time is not expected to noticeably increase because, at a constant accuracy, the measurement window scales with the spiking frequencies of the neurons. At a larger system size, however, spiking would likely become faster because the interconnect capacitances in the neuron would be substantially eliminated.

Using 130 nm technology, for example, if N becomes significantly larger than 1000, the chip could be increased in size or the spiking LCA could use multiple chips. In either case, capacitances would increase, increasing the synaptic time constant and, in turn, proportionately increasing convergence time.

For the measurement to be useful, the spike data is preferably retrieved from the chip in real time. An addressed event response (AER) system, for example, can be used to accomplish this task, but at the cost of significant extra power. Generally, this power is dominated by the cost of sending the address of each spike off-chip. Assuming a 10 bit address, a 50 pF load capacitance, and 2.4 V supply, for example, each spike would use about 1.5 nJ. The total number of spikes scales no faster than the root of the number of active neurons k, O\sqrt{k}. With a maximum input sparsity of approximately 60, this gives a maximum of 280,000 spikes per second, using 422 μW of power at peak activity.

Even with the AER power added, therefore, the hypothetical thousand neuron system compares extremely well with state-of-the-art digital BPDN implementations. Conventional BPDN can solve for N=1024 in 46 ms using an Intel i7 CPU. Estimating that this calculation required 1.2 GMACs over 46 ms, and that the i7 CPU calculates 7 GMAC/s/W, the estimated active power requirements for the calculation are approximately 3.8 W.⁸ This is approximately 500 times the active power used by the Spiking LCA. ⁸A. Borghi, J. Darbon, S. Peyronnet, T. F. Chan, S. Osher., A simple compressive sensing algorithm for parallel many-core architectures., Tech. rep., UCLA Computational and Applied Mathematics Technical Report (September 2008).

From the above discussion, and Table 1 it is clear that a spiking LCA has advantages over the non-spiking system. While exhibiting similar scaling properties for accuracy and convergence time, for example, the spiking LCA exhibits superior power scaling. A scaled implementation of the spiking LCA would be an advantageous platform for quickly solving large sparse approximation problems or any other neural network application that can benefit from precise synaptic programming.

### CONCLUSION

Embodiments of the present invention, including the LCA analog circuit disclosed herein, can provide efficient Hopfield network implementation, including solving sparse approximations with substantially identical accuracy as known digital solutions, but with vastly improved processing times. A pair of example circuits were implemented on the RASP 2.9 v and successfully converged on results that were substantially identical to known digital solvers. This analog solution can be particularly useful for, for example and not limitation, low powered applications, such as channel sensing for portable devices. Successful operation of the system at small sizes (N=6) has been demonstrated and simulations demonstrate the potential value of the LCA for larger system sizes.

The RASP 2.9 v described herein will allow moderate scaling of the LCA. The chip contains 18 8-bit DACs and enough stand-alone nFETs for 36 current mirrors. The thresholder nodes require two current minors, thus limiting the number of inputs M and outputs N to M+2N≦36. As a result, a practical maximum size of the current configuration is approximately 8×14. Scaling to this maximum size would not significantly impact total power output (which would still be dominated by overhead costs), and would only meaningfully impact the interface time to load and retrieve data (since convergence time is relatively fixed).

Scaling to much larger sizes (N≈1000) is easily achieved with multiple chips and/or application specific chips. This hypothetical chip would require approximately one million FGEs, which is implementable given the technology disclosed herein. The RASP 2.9a is a 5 mm×5 mm 350 nm process chip, for example, and contains 133,000 FGEs. Using a 130 nm process, on the other hand, would allow over one million FGEs on a chip the same size as the RASP 2.9 v.

At this scale, the convergence time would still not be expected to change markedly (since the capacitive load would not exceed that of a chip pad) as shown in the simulations. The total processing time would be dominated by interfacing costs, which would scale to approximately 4.4 ms. Improvements could be achieved by implementing some parallelization. Power consumption would be dominated by the O(N\sqrt{N}) scaling of the VMM OTAs, to about 149 mW. Accuracy would remain relatively constant, since the average error and average eigenvalue do not scale with problem size. These results are summarized in Table 2.

TABLE 2
Performance Comparison

| | System Size | | | | | | | |
|---|---|---|---|---|---|---|---|---|
| | LCA | | LCA | | LCA (Hyp.) | | CPU [29] | |
| | 2 × 3 | | 4 × 6 | | 666 × 1k | | 1k | |
| Power (Active) | 28.3 | μW | 74.6 | μW | 149 | mW | ≈3.8 | W |
| (Total) | 1.76 | mW | 1.81 | mW | 151 | mW | ≈100 | W |

| | | | | | | |
|---|---|---|---|---|---|---|
| Time (Cvg.) | 240 | μs | <240 | μs | 46 | ms |
| Time (Total) | 266 | μs | 4.62 | ms | 46 | ms |

| | | | | |
|---|---|---|---|---|
| Error (RMS) | 2% | 5% | ≈5% | — |
| Extra Cost | 0.2% | 1% | ≈1% | — |

These hypothetical results compare extremely well with state-of-the-art digital BPDN implementations. Conventional BPDN solutions, for example, consume more than 25 times more power than the LCA.

The LCA could also be increased to 4000 nodes by using a full 2 cm×2 cm reticle. In this configuration, the LCA would have more than 16 million devices. Further scaling could be achieved in several ways including, for example and not limitation, multiple chips or a denser chip process. Although the circuit shown here had only single sided inputs and outputs, multiple inputs/outputs could be used (e.g., four-quadrant behavior) can also be easily implemented. Extra nodes can be added to represent negative outputs, for example, while negative multiplication can be induced by simply connecting the driving VMM outputs to the negative input of the thresholding device (or for the recurrent VMM, connecting them to the positive input terminal). Of course, other configurations are possible and are contemplated herein.

The hardware LCA is easy to integrate into CS systems, for example, since it inherently contains mechanisms for rapid data interface. In addition, because the multipliers used here are reprogrammable, the system can also be used to recover arbitrary linear compressions of sparse signals (e.g., using a number of recovery methods). The multiplier weights can also be made to adapt to structure in the input and to learn more efficient dictionaries, enabling the system to be used even when the sparsity basis is unknown. In some embodiments, the system can be used in multiple applications including, but not limited to, CS recovery with ultra low power and/or real time processing.

Embodiments of the present invention can also comprise a Hopfield network comprising a spiking LCA network. The network can comprise, for example and not limitation, a network of 18 integrate and fire neurons and reconfigurable synapses, programmed on the RASP 2.9 v. This spiking network can be configured to be computationally equivalent to the LCA.

The fully implemented spiking LCA was able to converge on results in less than 25 μs. In addition, the system has superior power scaling properties relative to digital BPDN solutions and to non-spiking LCA implementations. Due to the extremely low power consumption, among other things, the spiking system can be advantageously used for high speed, low power applications, such as, for example and not limitation, channel sensing for portable devices.

While several possible embodiments are disclosed above, embodiments of the present invention are not so limited. For instance, while several possible configurations for the RASP 2.9 v have been disclosed, other suitable reconfigurable or custom chips could be selected without departing from the spirit of embodiments of the invention. The system and method are described above as a system for solving sparse matrices. One skilled in the art will recognize, however, that embodiments of the present invention are equally applicable to other optimization problems such as, for example, QPs/LPs. In addition, the location and configuration of components used for various embodiments of the present invention can be varied according to a particular application or installation that requires a slight variation due to, for example, the materials used and/or space or power constraints. Such changes are intended to be embraced within the scope of the invention.

The specific configurations, choice of materials, and the size and shape of various elements can be varied according to particular design specifications or constraints requiring a device, system, or method constructed according to the principles of the invention. Such changes are intended to be embraced within the scope of the invention. The presently disclosed embodiments, therefore, are considered in all respects to be illustrative and not restrictive. The scope of the invention is indicated by the appended claims, rather than the foregoing description, and all changes that come within the meaning and range of equivalents thereof are intended to be embraced therein.

1. A method comprising:
applying each of a plurality of input signals to each of a plurality of feedforward excitation signals to generate a plurality of first output signals;
applying each of a plurality of second output signals to each of a plurality of lateral inhibition signals to generate a plurality of recurrent feedback signals;
subtracting each the plurality of recurrent feedback signals from each of the plurality of first output signals to generate a plurality of intermediate signals; and
applying each of the plurality of intermediate signals to a non-linear computation to generate the plurality of second output signals.

2. The method of claim 1, further comprising:
converting a first sparse vector of a plurality of sparse vectors to a plurality of input signals.

3. The method of claim 1, wherein the plurality of feedforward excitation signals are applied by a first plurality of transistors that comprise a first analog vector matrix multiplier (VMM).

4. The method of claim 1, wherein the plurality of lateral inhibition signals are applied by a second plurality of transistors that comprise a second analog vector matrix multiplier (VMM).

5. The method of claim 1, wherein the subtraction step is performed by a plurality of current mirrors.

6. The method of claim 1, wherein each step is performed in parallel in continuous time for each input signal of the plurality of input signals.

7. The method of claim 6, wherein:
the plurality of first output signals and the plurality of recurrent feedback signals are analog; and
the plurality of second output signals are digital.

8. The method of claim 7, wherein one or more of the plurality of first output signals and the recurrent feedback signals change in response to a change in one or more of the plurality of second output signals.

9. The method of claim 8, wherein the change in one or more of the plurality of first output signals or the recurrent feedback signals acts as a low-pass filter.

10. An analog device comprising:
a plurality of first parallel linear computational devices for applying each of a plurality of input signals to each of a plurality of feedforward excitation signals to generate a plurality of first output signals;
a plurality of second parallel linear computational devices for applying each of a plurality of second output signals to each of a plurality of lateral inhibition signals to generate a plurality of recurrent feedback signals; and
a plurality of non-linear parallel computational devices for subtracting each of the plurality of recurrent feedback signals from each of the plurality of first input signals to generate a plurality of intermediate signals and applying each of the plurality of intermediate signals to generate the plurality of second output signals.

11. The device of claim 10, further comprising:
a plurality of digital-to-analog converters for converting a plurality of digital signals into the plurality of input signals.

12. The device of claim 10, wherein the plurality of first parallel linear computational devices comprises a first plurality of transistors forming a first analog vector matrix multiplier (VMM).

13. The device of claim 12, wherein each scalar multiplication in the first analog VMM requires only one of the first plurality of transistors.

14. The device of claim 12, wherein one or more of the first plurality of transistors are programmable.

15. The device of claim 10, wherein the plurality of second parallel linear computational devices comprise a second plurality of transistors forming a second analog VMM.

16. The device of claim 15, wherein each scalar multiplication in the second analog VMM requires only one of the plurality of transistors.

17. The device of claim 15, wherein one or more of the first plurality of transistors are programmable.

18. The device of claim 10, wherein the plurality non-linear parallel computational devices comprise a plurality of n-channel field effect transistors (nFET).

19. The device of claim 10, further comprising one or more low-pass filters.

20. The device of claim 10, wherein each of the plurality of non-linear parallel computational devices comprise an individually tunable negative offset and an integrate and fire neuron.

21. The device of claim 20, wherein the integrate and fire neurons comprise non-leaky integrate and fire neurons.

22. A system comprising:
a field programmable analog array (FPAA) comprising:
a first plurality of transistors forming a first vector multiplication matrix (VMM) for applying the each of the plurality of input signals to each of a plurality of feedforward excitation signals to generate a plurality of first output signals;
a second plurality of transistors forming a second vector multiplication matrix (VMM) for applying each of a plurality of second output signals to each of a plurality of lateral inhibition signals to generate a plurality of recurrent feedback signals; and
a plurality of modified current mirrors for subtracting each of the plurality of recurrent feedback signals from each of the plurality of first input signals to generate a plurality of intermediate signals and applying each of the plurality of intermediate signals to a non-linear computation to generate the plurality of second output signals.

23. The system of claim 22, a plurality of digital-to-analog converters for converting a first sparse vector from a plurality of sparse vectors into a plurality of input signals.

24. The system of claim 22, wherein each scalar multiplication in the first VMM or the second VMM requires only one transistor of the first or second plurality of transistors.

25. The system of claim 24, wherein each of the first and second plurality of transistors comprises one or more floating gates; and
wherein the charge on each of the one or more floating gates determines the weight of the scalar multiplication produced by that transistor.

26. The system of claim 22, wherein each of the modified current mirrors comprises a negative offset current.

27. The system of claim 26, wherein the negative offset current is individually tunable for each of the modified current minors.

28. The system of claim 26, wherein the negative offset current is provided by a floating gate transistor; and
wherein the charge of the floating gate transistor determines the magnitude of the negative current offset.

29. The system of claim 22, wherein the nonlinear computations comprise integrate and fire neurons.

30. The system of claim 29, wherein the integrate and fire neurons are non-leaky integrate and fire neurons.
